(19) United States
(12) Patent Application Publication
(10) Pub. No.: US 2026/0277556 A1
(43) Pub. Date: Sep. 17, 2026

(54) MIRRORING AUTONOMOUS SOFTWARE AGENT ACTIONS VIA A USER COMPUTING DEVICE INTERFACE AND ENABLING OPTIONS TO SWITCH BETWEEN DIFFERENT LEVELS OF AUTONOMY

(71) Applicant: COGNITION AI, INC., San Francisco, CA (US)

(72) Inventors: Walden Yan, Atherton, CA (US); Sampriti Panda, Menlo Park, CA (US)

(21) Appl. No.: 19/465,346

(22) Filed: Jan. 30, 2026

Related U.S. Application Data
(60) Provisional application No. 63/770,816, filed on Mar. 12, 2025.

(51) Int. Cl. G06F 8/33; G06F 8/34; G06F 9/455

(52) U.S. Cl. CPC G06F 8/33; G06F 8/34; G06F 9/45558; G06F 2009/4557

(57) ABSTRACT

The present disclosure relates to systems, methods, and non-transitory computer-readable media that deploys an autonomous software agent and displays actions taken by the autonomous software agent on a graphical user interface on a user computing device. In particular, the disclosed systems receive a request to deploy an autonomous software agent, and the disclosed systems use the autonomous software agent to generate computer code (e.g., utilizing an integrated development environment of the autonomous software agent). Moreover, the disclosed systems, in parallel with generating the computer code, provide, via the graphical user interface on the user computing device, the integrated development environment of the autonomous software agent, where the graphical user interface displays actions taken by the autonomous software agent while independently performing the software coding task.

### CROSS REFERENCE TO RELATED APPLICATIONS

This application claims the benefit of and priority to U.S. Provisional Application No. 63/770,816, filed Mar. 12, 2025. The aforementioned application is hereby incorporated by reference in its entirety.

### BACKGROUND

Advancements in computing devices and networking technology have given rise to a variety of innovations in machine learning and digital co-pilot assistants. Over time, computing systems have been developed that generate computer code to assist (e.g., in a co-pilot like manner) a software developer in completing their computer tasks. For instance, some existing systems can assist software developers in generating code by supplementing computer code or making tweaks to existing computer code. Despite these advances, however, existing systems continue to suffer from a number of disadvantages, particularly in terms of efficiency, accuracy, and flexibility.

### SUMMARY

One or more embodiments described herein provide benefits and/or solve one or more problems in the art with systems, methods, and non-transitory computer-readable media that deploy autonomous software agents to perform non-trivial programming tasks and in parallel, mirror their real-time actions via a graphical user interface on a user computing device. To illustrate, in one or more embodiments, the disclosed systems display (e.g., via the graphical user interface on the user computing device) a fully featured integrated development environment (i.e., an IDE) of the autonomous software agent that follows the actions (e.g., submitting terminal commands, editing code, writing new code, etc.) of the autonomous software agent. Moreover, in some embodiments, the disclosed systems enable the user computing device to seamlessly switch between different levels of autonomy for the autonomous software agent (e.g., allow the autonomous software agent to operate independently, pair programming with the autonomous software agent, user intervention to cause the autonomous software agent to stop performing a software coding task and the user computing device takes over the IDE).

Furthermore, in some embodiments, the disclosed systems provide a timelapse feature that enables a user computing device to scrub throughout a timeline of an entire development session for the autonomous software agent. In other words, the disclosed systems enable the aforementioned real-time view of the autonomous software agent’s work and the ability to jump to any point in time of a development session to see/review the progress/versions of the autonomous software agent’s work.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an overview diagram of an autonomous software agent system deploying an autonomous software agent and enabling options to switch between different levels of autonomy in accordance with one or more implementations;

FIG. 2 illustrates an example diagram of an autonomous software agent IDE and a user computing device IDE in accordance with one or more implementations;

FIG. 3 illustrates an example diagram of the autonomous software agent system deploying an autonomous software agent to generate computer code responsive to a request in accordance with one or more implementations;

FIG. 4 illustrates an example diagram of the autonomous software agent system enabling pair programming for a user computing device and an autonomous software agent in accordance with one or more implementations;

FIG. 5 illustrates an example diagram of the autonomous software agent system enabling user intervention to cause the autonomous software agent to pause/stop performing a software coding task in accordance with one or more implementations;

FIGS. 6A-6D illustrates example graphical user interfaces of an integrated development environment (IDE) of the autonomous software agent performing software coding tasks in accordance with one or more implementations;

FIG. 7 illustrates an example diagram of the autonomous software agent system merging generated computer code after deploying an autonomous software agent in accordance with one or more implementations;

FIG. 8 illustrates an example diagram of a timelapse feature to selectively review an integrated development environment (IDE) of the autonomous software agent in accordance with one or more implementations;

FIG. 9 illustrates an example graphical user interface of the timelapse feature in accordance with one or more implementations;

FIG. 10 illustrates an example diagram of the autonomous software agent system utilizing various artificial intelligence models of the autonomous software agent system to enable the fully featured integrated development environment (IDE) of the autonomous software agent and options to switch between different levels of autonomy;

FIGS. 11A-11B illustrates example diagrams of architectural components of an autonomous software agent deployed by the autonomous software agent system in accordance with one or more implementations;

FIG. 12 illustrates an example environment of the autonomous software agent system in accordance with one or more implementations;

FIG. 13 illustrates an example series of acts for deploying an autonomous software agent and providing for display, actions of the autonomous software agent in accordance with one or more implementations; and

FIG. 14 illustrates a block diagram of an exemplary computing device in accordance with one or more implementations.

### DETAILED DESCRIPTION

One or more embodiments described herein includes an autonomous software agent system that deploys an autonomous software agent and further enables options for a user computing device to interact, review, edit, and take over the autonomous software agent’s work. To illustrate, in one or more embodiments, the autonomous software agent system deploys an autonomous software agent to independently complete software development tasks leveraging a fully featured, AI-enabled integrated development environment (IDE), and interactive browser. In particular, the autonomous software agent system displays, via a graphical user interface on a user computing device, actions taken by the autonomous software agent while independently performing a software coding task.

In some embodiments, the autonomous software agent system provides options for a user computing device to switch between different levels of autonomy for the autonomous software agent executing a software coding task. For example, the autonomous software agent system enables a user computing device to continue to delegate entire tasks while the autonomous software agent is working completely asynchronously. Further, in some embodiments, the autonomous software agent system enables the user computing device to pair program live with the autonomous software agent in the IDE (e.g., using shortcuts and artificial intelligence features of an AI-native IDE), or work in a hybrid fashion (e.g., intervene and takeover/add finishing touches to the autonomous software agent’s code before merging the generated code). In some embodiments, the autonomous software agent system is faster and more responsive to feedback provided by a user computing device (e.g., relative to existing systems) and understands changes made by the user computing device without being notified of those changes (e.g., during user intervention or pair programming).

Accordingly, the autonomous software agent system provides a wide range of latitudes for a user computing device working with an autonomous software agent (e.g., parallelization of hundreds of software coding tasks across a codebase). In other words, the autonomous software agent system enables a true work alongside experience between a user computing device and an autonomous software agent without the user computing device needing to be the “driver” for a software development task. In particular, as mentioned above, the autonomous software agent system innovates the user computing device-AI software agent interface by providing flexibility to seamlessly switch between different autonomy levels.

Further, in some embodiments, the autonomous software agent system provides a timelapse feature to a user computing device to see an abstracted version of an autonomous software agent’s work. In other words, in addition to the real-time view of the autonomous software agent’s work mentioned above, the autonomous software agent system also allows a user computing device to selectively review the autonomous software agent’s work at any point in time of a development session.

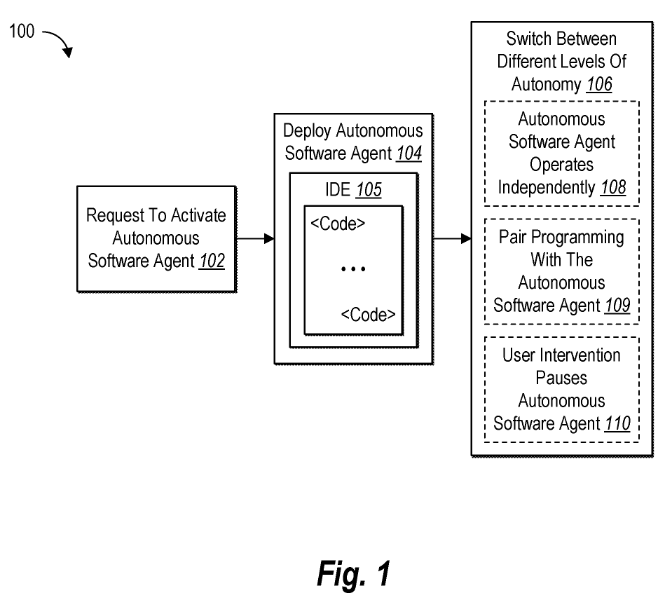

FIG. 1 illustrates an autonomous software agent system 100 deploying an autonomous software agent and enabling options to switch between different levels of autonomy in accordance with one or more embodiments. For example, FIG. 1 shows the autonomous software agent system 100 receiving a request 102 to activate an autonomous software agent 104. In one or more embodiments, the request 102 refers to a natural language prompt (from a user computing device), an application programming interface call, and/or a tag/mention in a messaging application. For example, the autonomous software agent system 100 can receive the request 102 as a natural language prompt via a web browser (e.g., a web interface to interact with Devin) of the autonomous software agent system 100.

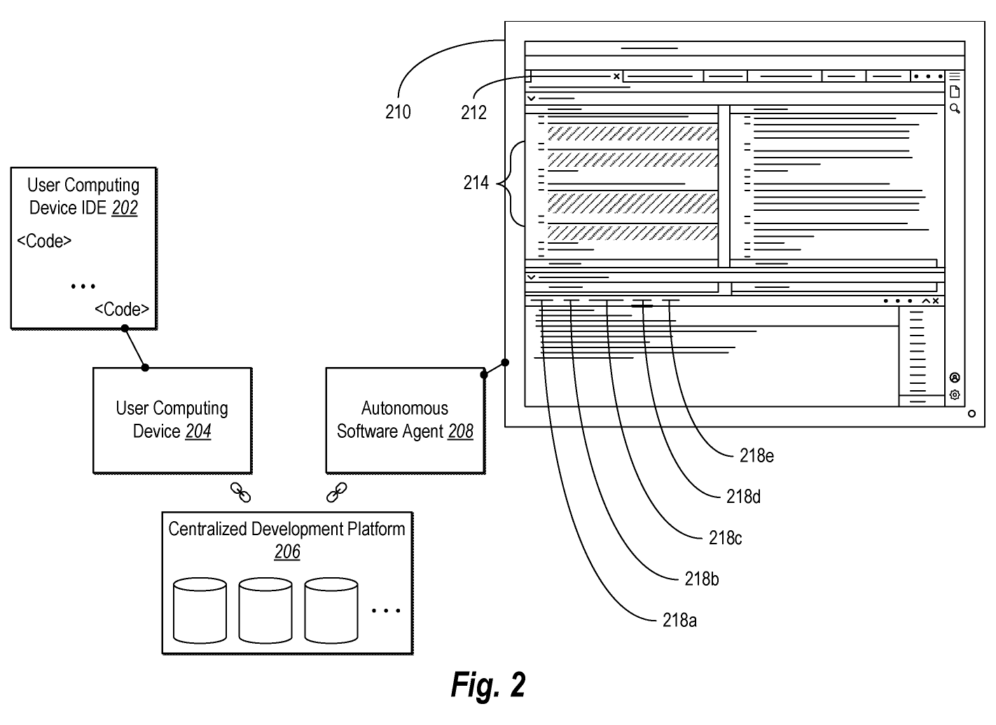

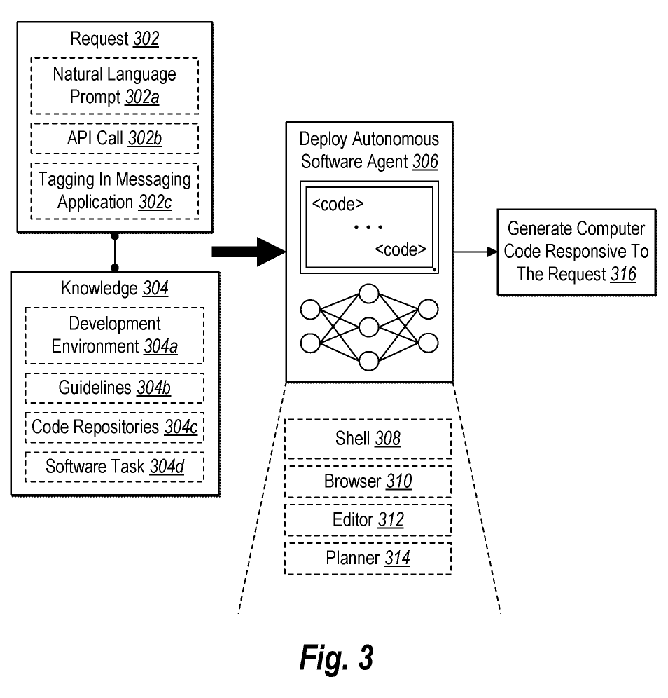

As shown in FIG. 1, in response to the request 102 to activate the autonomous software agent, the autonomous software agent system 100 performs an act of deploying an autonomous software agent 104. The request 102 is discussed in more detail below in the description of FIG. 3. As further shown in FIG. 1, the autonomous software agent 104 includes an IDE 105 (e.g., integrated development environment), which was mentioned above and is discussed in further detail below in the description of FIG. 2.

In one or more embodiments, the autonomous software agent 104 refers to a cloned virtual machine that is isolated and can perform tasks siloed from other computing devices. In some embodiments, the autonomous software agent 104 refers to an independent virtual machine computing device that generates and runs code in its own isolated environment (e.g., using a fully featured IDE). In other words, the autonomous software agent 104 exists independently of a user computing device (e.g., who submitted a prompt to deploy the autonomous software agent 104) and performs tasks based on knowledge that is provided to it.

In one or more embodiments, the autonomous software agent system 100 provides the autonomous software agent 104 with its own software development environment (e.g., fully featured IDE) to perform individualized tasks and not merely supplementary tasks (e.g., the autonomous software agent 104 can deploy its own codebase by replicating an existing codebase, make changes, implement changes, run tests, etc.). In some embodiments, the autonomous software agent 104 asks permission from a user computing device prior to implementing computer code changes.

As further shown in FIG. 1, the autonomous software agent system 100 enables options for a user computing device to perform an act 106 of seamlessly switching the autonomous software agent 104 to different levels of autonomy. In particular, FIG. 1 shows an option 108 of continuing to allow the autonomous software agent 104 to operate independently, an option 109 of a user computing device pair programming with the autonomous software agent 104, and an option 110 of user intervention (e.g., by the user computing device) to pause the autonomous software agent 104. Thus, the autonomous software agent system 100 enabling the options to switch between different levels of autonomy effectively allows a software developer to work on tens or hundreds of software development tasks across one or more codebases in parallel.

To illustrate, the autonomous software agent system 100 enables a software developer to effectively open an infinite number of windows in their IDE to work simultaneously on different tasks (e.g., via the autonomous software agent 104 operating in its own fully featured IDE). Accordingly, the autonomous software agent system 100 enables enhanced parallelization for faster feedback, review, and editing (e.g., relative to existing systems) by deploying the autonomous software agent 104 and allowing the user computing device to switch between different levels of autonomy.

In other words, the autonomous software agent system 100 enhances the parallelization of tasks by enabling an improved and viable workflow loop for faster feedback and review from a user computing device for work performed by the autonomous software agent and editing by the user computing device. In particular, due to the seamless ability to switch between different levels of autonomy for the autonomous software agent, the autonomous software agent system 100 provides a much more viable framework for leveraging autonomous software agents to simultaneously perform hundreds of complex non-trivial software coding tasks. Additional details of the autonomous software agent system 100 enabling the options of different autonomy levels is given below in the description of FIGS. 3-7.

As mentioned above, existing systems are inefficient. For example, existing systems provide code generation assistant features to assist a developer in completing their software tasks. However, these existing systems merely supplement developer work. In particular, existing systems require heavily involved guidance, prompting, monitoring, and the use of a developer’s device in order to supplement developer work. In other words, existing systems merely act as a co-pilot to a developer. Accordingly, existing systems suffer from computational inefficiencies of attempting to integrate a code development assistant into a developer’s workflow and often suffer from being prompted and re-prompted to yield satisfactory results (e.g., which results in wasted computational resources).

In addition to their inefficiency issues, existing systems are also inaccurate. More particularly, due to the standard paradigm of existing systems supplementing code development, existing systems are often incomplete or inadequate in generating complex and extensive computer code. Moreover, existing systems often supplement code development efforts but generate computer code that inaccurately addresses an intent (expressed by an input prompt) and/or that is operationally invalid, including syntactic errors, semantic errors, and/or logical errors.

In particular, existing systems may be able to generate computer code to supplement a developer’s task, however it is often difficult or impossible to follow/understand the thought process of existing code generation systems writing computer code. Often, existing code generation systems are a black box that receive instructions and output computer code (e.g., which results in difficulties understanding how the existing code generation system arrived at its answer). As such, modifying intermediate steps of a (supplementary) software coding task performed by existing code generation systems are often infeasible.

Relatedly, existing systems suffer from operational inflexibility. Because existing systems are limited to supplementing code development for cases expressly coded by engineers, these existing systems fail to adapt to creating new computer code, tackling complex non-trivial tasks, correctly understanding already generated computer code and/or effectively performing tests on computer code. Indeed, the inflexible nature of existing systems severely hampers the ability of existing systems to keep up with the taxing demands of software development from a holistic perspective. In other words, existing systems are stuck as operating as a co-pilot developer to merely supplement a software developer’s workflow.

In one or more embodiments, the autonomous software agent system 100 provides several improvements over conventional systems in relation to efficiency, accuracy, and operational flexibility. In contrast to existing systems, which require heavily involved guidance, prompting, monitoring, and the use of a developer’s device (in order to supplement developer work), the autonomous software agent system 100 deploys an autonomous software agent that operates as an independent virtual machine computing device.

In doing so, the autonomous software agent system 100 allows for an autonomous software agent to operate independently to solve non-trivial tasks, and it does not conflate or confuse context of other ongoing tasks. Specifically, the autonomous software agent system 100 silos/isolates autonomous software agents (e.g., to operate independently with a fully featured IDE) such that the autonomous software agents can accurately and efficiently perform their assigned tasks without being bogged down by additional information.

Moreover, the autonomous software agent system 100 also improves efficiency of software coding tasks by enabling options for a user computing device to switch between different levels of autonomy for the autonomous software agent. In particular, as mentioned, the autonomous software agent can operate independently, can operate in a pair programming mode with a user computing device, or a user computing device can completely intervene in an IDE of an autonomous software agent and write/edit computer code. In other words, the autonomous software agent system 100 allows a user computing device to truly work alongside an autonomous software agent, without the user computing device needing to be in the driver’s seat (e.g., the autonomous software agent is not merely relegated to a co-pilot role).

Furthermore, the autonomous software agent system 100 improves efficiency by enabling a user computing device to continue to delegate entire non-trivial software coding tasks to the autonomous software agent while the autonomous software agent is already working completely asynchronously. As the autonomous software agent is executing a software coding task, the user computing device can pair program or intervene in the task that is being performed by the autonomous software agent. Thus, the autonomous software agent system 100 enables large scale parallelization of tasks.

Moreover, the autonomous software agent system 100 enables a user computing device to delegate a software coding task to the autonomous software agent that the autonomous software agent would not be able to one-shot (e.g., complete in a single attempt without intervention). In doing so, the user computing device can wait until the autonomous software agent has reached a certain point, and then the user computing device can intervene in the software coding task.

Thus, the user computing device can more effectively complete software coding tasks by having the autonomous software agent perform the majority of it, and then the user computing device can complete the remainder of the task. In other words, the autonomous software agent system 100 improves the efficiency at which tasks are delegated and completed by an autonomous software agent.

In one or more embodiments, the autonomous software agent system 100 further improves upon inaccuracies. In contrast to existing systems, which are often incomplete or inadequate in generating complex and extensive computer code, the autonomous software agent system 100 deploys an autonomous software agent to complete a software coding task and enables options for a user computing device to intervene/pair program at various points of the software development task. In particular, the autonomous software agent system 100 provides, via a graphical user interface on a user computing device (in parallel with the autonomous software agent generating computer code), an IDE of the autonomous software agent. For instance, the graphical user interface on the user computing device displays actions taken by the autonomous software agent.

In other words, the autonomous software agent system 100 enables a user computing device to follow the work of an autonomous software agent as it performs a software coding task in the fully featured IDE. For example, the autonomous software agent system 100 displays commands submitted by the autonomous software agent via a terminal, computer code being written by the autonomous software agent via an editor, computer code being debugged by the autonomous software agent, etc. As such, the autonomous software agent system 100 enables a user computing device to more accurately understand the manner in which an autonomous software agent arrived at a final result (e.g., the user computing device can follow the autonomous software agent in real-time).

Furthermore, the autonomous software agent system 100 enables the user computing device to accurately intervene in an autonomous software agent’s task or to provide guidance when pair programming with the autonomous software agent. Thus, the autonomous software agent system 100 improves the overall accuracy of an autonomous software agent performing non-trivial software development tasks.

Additionally, the autonomous software agent system 100 further improves the accuracy (e.g., relative to existing systems) by providing a timelapse feature. In particular, the autonomous software agent system 100 provides the timelapse feature which allows a user computing device to selective review the IDE of the autonomous software agent across a development session. As such, the autonomous software agent system 100 enables a user computing device to spot/identify issues throughout a development session and to make changes to enhance the overall process of the autonomous software agent performing a software coding task.

Unlike existing solutions (e.g., Copilot, Claude Code, and various session recorders), the autonomous software agent system 100 allows for a user computing device to jump in at any point in time of a development session to see the progress/versions of the work. Moreover, unlike existing solutions, the autonomous software agent system 100 also provides for selective review in real-time as an autonomous software agent is executing a software task during a development session.

In one or more embodiments, the autonomous software agent system 100 further improves upon operational inflexibility. In contrast to existing systems, which are rigidly tied to code supplementation, the autonomous software agent system 100 deploys an autonomous software agent that operates as an independent virtual machine computing device and further allows a user to monitor/modify the progress of the autonomous software agent (if so desired). Moreover, because the autonomous software agent system 100 deploys an autonomous software agent that is provided with fully featured IDE (e.g., browser, planner, editor, and shell), the autonomous software agent acts as an advanced reasoning tool to complete non-trivial tasks.

Furthermore, the autonomous software agent system 100 improves operational flexibility by innovating the user computing device-software agent interface by providing flexibility to switch between different levels of autonomy. This allows a user computing device to interact with the autonomous software agent in a manner not previously available in existing systems. Accordingly, the autonomous software agent system enhances the flexibility of operations by enabling massive parallelization of software coding tasks (e.g., improving efficiency) and accuracy of completing software development tasks (e.g., innovating the interaction experience with between a user computing device and the autonomous software agent) via an autonomous software agent.

FIG. 2 illustrates the autonomous software agent system 100 deploying an autonomous software agent that operates alongside a user computing device in a centralized development platform in accordance with one or more embodiments. For example, FIG. 2 shows the autonomous software agent system 100 working alongside a user computing device 204 in a centralized development platform 206.

In one or more embodiments, the user computing device 204 refers to a device that interacts with computer systems, access code repositories, write computer code, and run applications. In particular, the user computing device 204 is typically operated by a user to perform the aforementioned acts. For example, the user computing device 204 can process data and perform various software coding tasks based on input received from a user.

In some embodiments, the user computing device 204 is part of the centralized development platform 206 (e.g., an organization specific Github) with a plurality of additional user computing devices. Moreover, in some embodiments, the centralized development platform 206 is also accessed by the autonomous software agent 208 (e.g., via access permissions granted to the autonomous software agent 208 by one or more user computing devices part of the centralized development platform 206).

In one or more embodiments, the centralized development platform 206 refers to a collaborative software environment where software developer computing devices (e.g., user computing devices) access, build, test, and deploy computer code software for a unified platform. In particular, the centralized development platform 206 can include source code, code repositories (e.g., code libraries), and code documentation. Moreover, when a software developer computing device adds/modifies computer code in the centralized development platform 206, the software developer computing device can track changes made to the code (e.g., leave comments).

As is just mentioned, the centralized development platform 206 includes one or more code repositories. In one or more embodiments, a code repository refers to a centralized location where software computer code is stored, managed, and controlled (e.g., controlled for different deployment versions such as development, web application, cloud, etc.). In particular, the code repository includes computer code, computer code documentation (e.g., files explaining how to use, setup, and contribute to one or more projects), configuration files (e.g., environment configuration, application configuration, deployment configuration, etc.) , and assets (e.g., images, CSS files, JavaScript files, fonts, external libraries, audio/video files, etc.).

In some embodiments, software applications/systems utilize one or more code repositories to organize computer code, collaborate on computer code projects, and maintain computer code over time. In other words, a code repository enables multiple software developer computing devices to collaborate on computer code projects (e.g., software development teams can upload and download changes to and from the code repository) by creating branches to work on specific features or computer code bugs. Once a branch is completed, software developer computing devices can merge their changes into the code repository (e.g., which results in other software developer computing devices with access to the code repository being able to access the changes).

As further shown in FIG. 2, the autonomous software agent system 100 provides the autonomous software agent 208 and the user computing device 204 with their own integrated development environment (IDE). In particular, FIG. 2 shows an integrated development environment 210 for the autonomous software agent 208 and an integrated development environment 202 for the user computing device 204.

In some embodiments, an integrated development environment (IDE) refers to a software application that brings together software tools for software development into a unified graphical user interface. In particular, the integrated development environment refers to a software application that combines essential software development features (e.g., coding, debugging, testing, and deployment) to increase the efficiency of completing software projects.

In some embodiments, the integrated development environment is a fully featured application that allows an autonomous software agent and/or a user computing device to write, test, and debug code without switching between different software applications. For example, the integrated development environment can include a code editor (e.g., syntax highlighting, code completion, etc.), a compiler/interpreter (e.g., converts source code into executable program code), a debugger (e.g., to find and fix computer code errors), a file browser (e.g., to navigate through files in a centralized development platform), version control (e.g., commit, push, pull, merge computer code in a code repository), and a terminal (e.g., direct command execution to run scripts or access computer system utilities).

Accordingly, the autonomous software agent system 100 provides the autonomous software agent 208 with its own fully featured IDE (e.g., independent of the integrated development environment 202 of the user computing device 204) to perform non-trivial software coding tasks. In other words, the autonomous software agent 208 has full access to the IDE 210, which enables the autonomous software agent 208 to complete complex software development tasks.

FIG. 2 shows the IDE 210 of the autonomous software agent 208 that includes an editor tab 212 (e.g., FIG. 2 shows multiple editor tabs which represent open files in an editor area of the IDE 210 for writing/editing computer code). In particular, the editor tab 212 corresponds to an open file. Further, FIG. 2 shows that for a relevant editor tab, the autonomous software agent 208 also has access to an editor 214 for writing/editing computer code.

Moreover, FIG. 2 shows a problems tab 218a (e.g., lists errors, warnings, and information for computer code (in the editor tab) to efficiently see errors in computer code or jump to problematic portions of computer code), an output tab 218b (e.g., shows logs and messages from the IDE 210 or extensions of the IDE to be notified of background activities like loading data onto a server or plugin operations), a debug console 218c (e.g., allows for interactions with a program during debugging, such as viewing runtime logs, evaluating expressions, or inspecting variables), a terminal 218d (e.g., a built-in shell/command-line interface for executing/submitting commands to a terminal, such as running scripts or installing packages), and a version control tab 218e (e.g., provides information as to which devices submitted changes to a code repository and why the changes were submitted to a code repository).

FIG. 3 illustrates the autonomous software agent system 100 deploying an autonomous software agent to independently execute a software coding task in accordance with one or more embodiments. In particular, FIG. 3 shows the autonomous software agent system 100 accessing/receiving a request 302 (e.g., from a user computing device). As mentioned above, the request 302 refers to a natural language prompt 302a, an application programming interface call 302b, and/or a tag/mention in a messaging application 302c.

In some embodiments, via an API, a user computing device can build custom workflows using an API of the autonomous software agent system 100 and programmatically assign tasks for the autonomous software agent system 100 to perform. Further, with the API, user computing devices can essentially plug in the autonomous software agent system 100 to any of their software development and internal tools.

In some embodiments, the autonomous software agent system 100 deploys an autonomous software agent in response to being triggered by a code editor. In particular, from another code editor/integrated development environment (IDE), user computing devices who use visual studio code (or visual studio code forks) can assign tasks to the autonomous software agent system 100 directly from their code editor/IDE.

In some embodiments, the autonomous software agent system 100 can deploy an autonomous software agent in response to being tagged/mentioned in the messaging application 302c. In particular, a user computing device can tag the autonomous software agent system 100 directly from conversations with other user computing devices in the messaging application 302c. Furthermore, the autonomous software agent system 100 will reply directly in the messaging thread and anyone can jump into the thread and provide further instructions to the autonomous software agent system 100. Moreover, the autonomous software agent system 100 can react to messages with emojis, text, multimedia, or any other response form that a user may employ.

In some embodiments, the autonomous software agent system 100 integrated with the messaging application 302c further includes a centralized server. In particular, the autonomous software agent system 100 utilizes a centralized server that is responsible for forwarding information between the autonomous software agent system 100 and the messaging application 302c. To illustrate, a user computing device can install a messaging integration for the autonomous software agent system 100 into a messaging workspace and further add the integration to the relevant channels of the messaging application 302c.

In some embodiments, if the autonomous software agent system 100 receives a tag/mention of an autonomous software agent (e.g., Devin) in the messaging application, then the autonomous software agent system 100 utilizes a centralized server to recognize the tag/mention. Furthermore, the autonomous software agent system 100 passes that tag/mention along to a web server backend (e.g., a website hosted by the autonomous software agent system 100) to start a new session (e.g., initiate an autonomous software agent for deployment).

Further, in some embodiments, the autonomous software agent system 100 synchronizes a conversation that happens in a messaging application with what happens in a web application of the autonomous software agent system 100. In particular, if a user computing device interacts with the autonomous software agent system 100 in the messaging application 302c, then that user computing device is also interacting with the autonomous software agent system 100 in the web application. Moreover, messages received by the autonomous software agent system 100 via the web application is displayed in the messaging application.

Additionally, in some embodiments, the autonomous software agent system 100 sends messages to one or more user computing devices. In particular, when the autonomous software agent system 100 wants to send a message, the autonomous software agent system 100 stores the message in a database and simultaneously, the web server detects the presence of this message. Further, the autonomous software agent system 100 causes the web server to put the message from the autonomous software agent system 100 in the web application (retrieves the messages). In some embodiments, the server for the messaging application 302c detects the message and forwards the message using an application programming interface of the messaging application 302c (e.g., using the relevant conversation).

In some embodiments, in response to reactions to messages in the messaging application, the responses are extracted and forwarded to the autonomous software agent system 100. Furthermore, the autonomous software agent system 100 preserves messages even if server devices are stalled/goes down. In particular, the autonomous software agent system 100 stores messages in a database and flags messages as either processed or not processed.

In some embodiments, the autonomous software agent system 100 intakes thread context in a messaging application and sends the whole contents of the conversation for downstream processing using an artificial intelligence model. In particular, the autonomous software agent system 100 processes the entire contents of a messaging thread to determine a context, background, and understanding of the entire thread, for example, utilizing a machine learning model such as a large language model.

In some embodiments, the autonomous software agent system 100 integrates with various version control managers (e.g., Git Managers for interacting with code repositories, such as committing, branching, merging, resolving conflicts, and pushing/pulling changes to a code repository). In particular, in response to pull requests (e.g., GitHub pull requests), the autonomous software agent system 100 will propose some code to be merged in the codebase.

Further, in some embodiments, the autonomous software agent system 100 prepares a notification channel that users can set in their messaging application integration settings to be notified of certain pull requests and acts performed by the autonomous software agent system 100 (e.g., via an autonomous software agent).

In some embodiments, the autonomous software agent system 100 seamlessly synchronizes with version control managers. In particular, when user computing devices sign up for an account with the autonomous software agent system 100, the user computing devices can connect with their version control manager (e.g., Github organization), which involves installing a version control application (e.g., Github application) into their workspace. Moreover, as mentioned, the autonomous software agent system 100 provides integration with a version control manager (Github), which allows the autonomous software agent system 100 to perform various actions, such as creating PULL requests, commenting on GitHub pull requests, reviewing GitActions (e.g., their code did not pass the check you cannot merge this code).

In some embodiments, the autonomous software agent system 100 accounts for different directions that information flows. In particular, the autonomous software agent system 100 accounts for when user computing devices intervene in a software coding task, pair program alongside an autonomous software agent, leave comments on pull requests from the autonomous software agent system 100, and reactions to pull requests (e.g., that information is passed on to the relevant model of the autonomous software agent system 100 that is managing the GitHub pull request).

In other words, the autonomous software agent system 100 allows for a two-way conversation (e.g., the autonomous software agent system 100 can make a pull request and when engineers leave feedback, the autonomous software agent system 100 takes that feedback into account) and accounts for any changes (e.g., computer code changes) that a user computing device makes during a development session.

As further shown in FIG. 3, the autonomous software agent system 100 further accesses/receives knowledge 304. In particular, the knowledge 304 can include a development environment 304a, guidelines 304b, code repositories 304c, and/or one or more software tasks 304d. In particular, knowledge refers to a form of “memory” that allows the autonomous software agent system 100 to retrieve information based on specific triggers that might be relevant to a session of the autonomous software agent.

Further, the autonomous software agent system 100 can retrieve the knowledge 304 (depending on the trigger) across all development sessions. In some embodiments, user computing devices can specify conditions/triggers for when certain types of knowledge are available to an autonomous software agent. To illustrate, the autonomous software agent system 100 utilizes a retrieval-augmented generation (RAG), which refers to retrieving relevant information from an external database or knowledge source.

Further, RAG includes using a large language model to generate a response leveraging both the retrieved information and its own internal knowledge base. In particular, the autonomous software agent system 100 leverages RAG, which includes an input query, information retrieval, and response generation to perform software coding tasks.

As further shown in FIG. 3, the autonomous software agent system 100 further performs an act 306 of deploying an autonomous software agent (e.g., a cloned virtual machine that is isolated and can perform tasks siloed from other computing devices). Moreover, as shown in FIG. 3, the autonomous software agent system 100 further provides to the autonomous software agent a shell 308, a browser 310, an editor 312, and a planner 314 (e.g., as part of the fully featured IDE discussed above).

As mentioned above, the autonomous software agent system 100 provides the combination of development tools to an autonomous software agent and outperforms existing methods due to its advanced reasoning capabilities. In particular, the autonomous software agent system 100 utilizes an autonomous software agent with a chain-of-though reasoning model to break down meta-tasks into multiple intermediate tasks.

Furthermore, the autonomous software agent system 100 uses the browser 310 to obtain needed information (e.g., to browse blogs, documentation, etc.) responsive to intermediate tasks, uses the shell 308 to make terminal calls (e.g., responsive to intermediate tasks), and further uses the editor 312 to draft computer code (e.g., in an isolated environment) to accomplish each portion of a meta-task. Thus, the combination of software development tools enables the advanced capabilities of an autonomous software agent. Accordingly, the autonomous software agent system 100 allows a user computing device to perform non-trivial programming tasks using an autonomous software agent that can independently write, run, test, and deploy computer code (e.g., if so desired).

In some embodiments, the autonomous software agent system 100 uses an autonomous software agent that includes one or more machine learning models, neural networks, and/or large language models. Thus, the autonomous software agent system 100 deploys an autonomous software agent that acts as an independent virtual machine computing device with various machine learning components used to analyze, process, and generate information.

In one or more embodiments a machine learning model includes a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data.

To illustrate, in some embodiments, a neural network includes a convolutional neural network, a recurrent neural network (e.g., a long short-term memory neural network), a transformer neural network, a generative adversarial neural network, a graph neural network, a diffusion neural network, a multi-layer perceptron, a large language model (LLM), a generative pre-trained transformer model (GPT), a chain-of-thought machine learning model, etc. In some embodiments, a neural network includes a combination of neural networks or neural network components.

In one or more embodiments, a model includes a language model that includes a set of statistical or probabilistic functions to perform Natural Language Processing (NLP) in order to understand, learn, and/or generate human natural language content. For example, the autonomous software agent system 100 uses a language model as a tool that determines the probability of a given sequence of words occurring in a sentence or natural language sequence.

Simply put, the autonomous software agent system 100 uses a model that is trained to predict the next word in a sentence. A language model is called a large language model (LLM) when it is trained on an enormous amount of data (e.g., a threshold amount of data) and/or has a large number of parameters. These models have capabilities ranging from writing a simple essay to generating complex computer codes – all with limited to no supervision.

Accordingly, an LLM can comprise a deep neural network that is very large (billions to hundreds of billions of parameters) and understands, processes, and produces human natural language by being trained on massive amounts of text. These models predict future words in a sentence letting them generate sentences similar to how humans talk and write or otherwise in a form dictated, for instance, by a prompt. In one or more implementations, an LLM utilized by the autonomous software agent system 100 employs a “chain-of-thought” reasoning approach that allows the model to internally deliberate before providing responses. Indeed, one or more implementations include a LLM trained using reinforcement learning techniques that enable the LLM to refine its reasoning skills through iterative feedback.

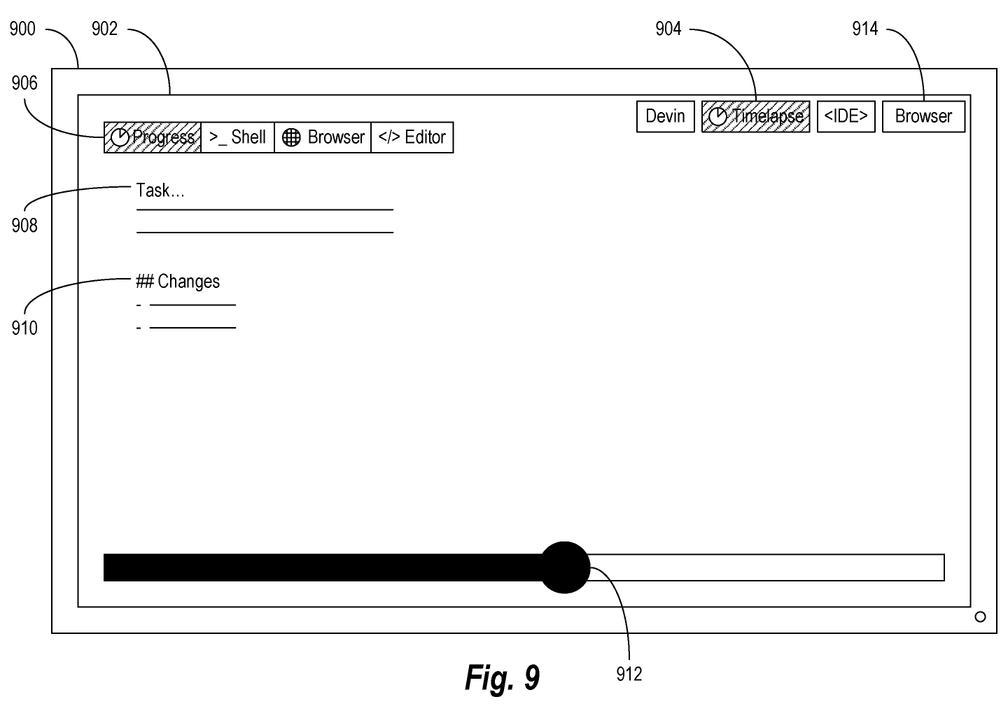

In some embodiments, the shell 308 refers to a text-based interface where the autonomous software agent system 100 can input commands that interact directly with a computer’s operating system. In some embodiments, the browser 310 refers to an interface that an autonomous software agent utilizes to browse documentation on the World Wide Web, tests web applications it builds, download/upload information, etc. Moreover, a user computing device can jump in to help the autonomous software agent navigate through browsing tasks via an interactive browser (e.g., which is discussed in more detail below in FIG. 9).

In some embodiments, the editor 312 refers to where the autonomous software agent system 100 writes computer code. In particular, the autonomous software agent system 100 allows a user computing device to supervise, review and edit the computer code written by the autonomous software agent system 100. Further, in some embodiments, the planner 314 refers to a running “to do” list that is broken down and laid out by the autonomous software agent system 100 in order to complete a task. In particular, the planner 314 allows a user to visualize how the autonomous software agent (e.g., deployed by the autonomous software agent system 100) plans and thinks through solving a problem. Furthermore, as shown in FIG. 3, the autonomous software agent system 100 further performs an act 316 of generating computer code responsive to the request 302.

In some embodiments, computer code includes a set of instructions written in a programming language that a computing device can interpret and execute to perform a specific task. In particular, computer code includes a series of statements and functions that execute specific operations. Further, computer code includes statements written in specific syntax and translatable into machine code to be executed by a computing device.

Further, computer code can include function code and test code. As used herein, the term function code refers to a set of instructions written in a programming language that a computing device can interpret and execute to perform a specific task. Function code can include a series of statements and functions that define specific operations or processes performed by a computer upon execution of the code. In some cases, function code includes statements written in specific syntax and translatable into machine code to be executed by a computing device for performing one or more processes of an overall intent.

As used herein, the term test code refers to computer code that defines a function test for function code. For example, text code can include one or more code segments for determining that the function code satisfies an intent query. In some cases, the autonomous software agent system 100 utilizes test code to test function code. For example, the autonomous software agent system 100 generates the test code that includes computer code for testing whether the output of function code satisfies an intent query. In some embodiments, test code can also test for different types of errors (e.g., syntax errors and logic errors) and/or for hazardous or harmful function code.

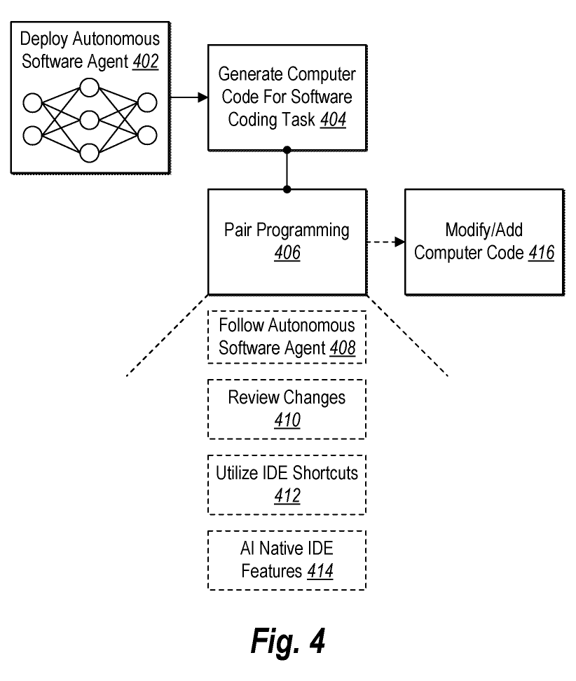

FIG. 4 illustrates the autonomous software agent system 100 enabling an option for pair programming with an autonomous software agent in accordance with one or more embodiments. For example, FIG. 4 shows the autonomous software agent system 100 deploying an autonomous software agent 402 and utilizing the autonomous software agent 402 to generate computer code 404 for a software coding task.

Moreover, FIG. 4 shows the autonomous software agent system 100 enabling an option to perform pair programming 406. In particular, the autonomous software agent system 100 provides the pair programming 406 as a selectable graphical user interface element via a graphical user interface of a user computing device. For instance, the autonomous software agent system 100 provides an option to follow (e.g., follow Devin) the autonomous software agent (e.g., follow actions performed by the autonomous software agent 402 while independently executing a software coding task) and then also provides an option to pair program with the autonomous software agent 402.

In some embodiments, the pair programming 406 refers to at least two software developers working together (e.g., a user computing device and an autonomous software agent). For example, pair programming can include a driver who actively writes computer code and a navigator who reviews the code and provides feedback/guidance to the driver. In particular, pair programming can include the autonomous software agent 402 acting as the driver and the user computing device acting as the navigator. For instance, the autonomous software agent 402 actively focuses on writing computer code while the user computing device provides high-level guidance to suggest changes to the autonomous software agent 402.

FIG. 4 shows pair programming as including an act 408 of following the autonomous software agent 402, an act 410 of reviewing changes made by the autonomous software agent 402, an act 412 of utilizing IDE shortcuts, and an act 414 of utilizing AI (artificial intelligence) native IDE features. In other words, a user computing device can pair program with the autonomous software agent 402 by reviewing work already completed by the autonomous software agent 402 (e.g., and in some instances, choosing to intervene based on what the autonomous software agent 402 has done). As already mentioned above, the autonomous software agent system 100 allows a user computing device to follow the autonomous software agent 402 operating independently to complete a software coding task.

Moreover, the act 410 of reviewing changes includes a user computing device examining computer code written by the autonomous software agent 402 during a development session. In particular, the act 410 of reviewing changs includes checking for computer code bugs, logic errors, code styling, readability, naming conventions, and responsiveness (e.g., accuracy) to a request to perform a software coding task.

Further, the act 412 of utilizing IDE shortcuts includes shortcuts such as a quick file search (e.g., jump to any file in the software coding project the autonomous software agent 402 is working on), commenting (e.g., comment or uncommenting a selected line of code), global search (jump to a function, class or variable), autocomplete (e.g., show suggestions for code completion), move line up/down (e.g., reorder lines of code without copy/pasting), select all occurrences of a current word, jump to a matching bracket, start debugging, and toggle terminal (e.g., open or hide a terminal).

Additionally, in some embodiments, the act 414 of utilizing AI native IDE features, includes AI code completion (e.g., predicting and autocompleting lines of computer code based on the existing content), natural language to code, code explanation, refactor suggestions (e.g., cleaner more efficient ways to express code), unit test generation, bug detection, inline documentation (e.g., comments or documentation), and a code search (e.g., utilizing an intelligent repository search system). Furthermore, as shown in FIG. 4, the autonomous software agent system 100 uses the autonomous software agent 402 to perform an act 416 of modifying/adding computer code to already generated computer code.

In one or more embodiments, the autonomous software agent system 100 considers the context of the pair programming 406 when performing the act 416 of generating/modifying computer code (e.g., via the autonomous software agent 402). In particular, in response to a user computing device performing one or more acts during pair programming, the autonomous software agent system 100 utilizes the one or more acts as context for generating additional computer code. For instance, the autonomous software agent system 100 considers comments left by the user computing device, global searches, initiated autocompletes, etc. Moreover, the autonomous software agent system 100 transfers this context to the autonomous software agent 402 when the autonomous software agent is executing (resuming) a software coding task.

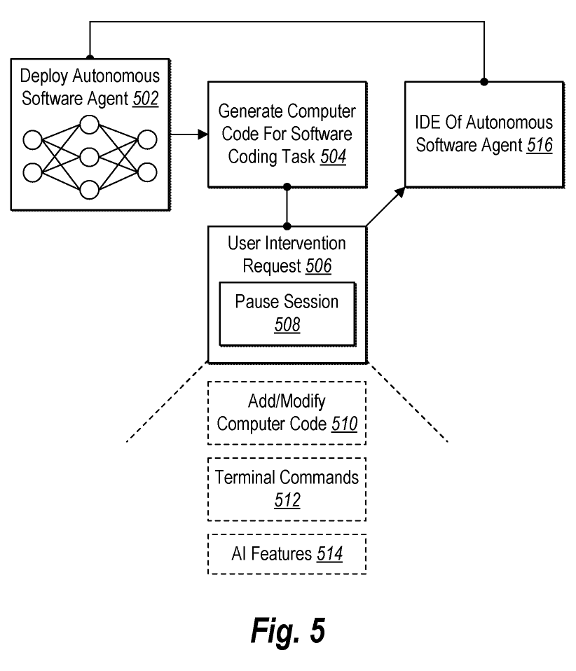

FIG. 5 illustrates the autonomous software agent system 100 receiving a user intervention request, which causes an autonomous software agent to pause a software coding task in accordance with one or more embodiments. For example, FIG. 5 shows the autonomous software agent system 100 deploying an autonomous software agent 502, which proceeds to perform an act 504 of generating computer code for a software coding task.

Moreover, FIG. 5 shows the autonomous software agent system 100 receiving a user intervention request 506. In one or more embodiments, the user intervention request 506 refers to an indication from a user computing device to pause/stop the autonomous software agent 502 from executing a software coding task. In particular, the user intervention request 506 causes the autonomous software agent 502 to not write/modify additional computer code, or perform any additional actions (e.g., submit terminal commands, search for project files, compile code, debug, etc.). For example, the autonomous software agent system 100 provides the user intervention request 506 as a method for switching the autonomous software agent 502 to the lowest level of autonomy. In doing so, a user computing device can intervene in the work completed thus far by the autonomous software agent 502. Accordingly, the user intervention request 506 allows a user computing device to more effectively push a software task to completion.

As shown in FIG. 5, the autonomous software agent system 100 receives the user intervention request 506 which causes the autonomous software agent system 100 to perform an act 508 of pausing a development session. Moreover, in response to receiving the user intervention request 506 and pausing a development session, the autonomous software agent system 100 also provides option(s) for a user computing device.

As shown in FIG. 5, the user intervention request 506 causes the autonomous software agent system 100 to pause a development session and give a user computing device access to an IDE 516 of the autonomous software agent 502. In some embodiments, the autonomous software agent system 100 allows a user computing device to perform an act 510 of adding/modifying computer code via a fully featured IDE of the autonomous software agent 502, an act 512 of submitting terminal commands via the IDE 516 of the autonomous software agent 502, and/or leverage AI features 514 (AI native IDE features) discussed above.

Although not shown in FIGS. 4 and 5, in one or more embodiments, the autonomous software agent system 100 receives input from a user computing device (e.g., during pair programming and/or user intervention). In such instances, the autonomous software agent system 100 seamlessly considers the input as contextual data for the deployed autonomous software agent when/if the work of the autonomous software agent is resumed. In other words, the user computing device does not have to notify the autonomous software agent of the changes/additions, rather the autonomous software agent system 100 considers (in real-time) any input provided by the user computing device.

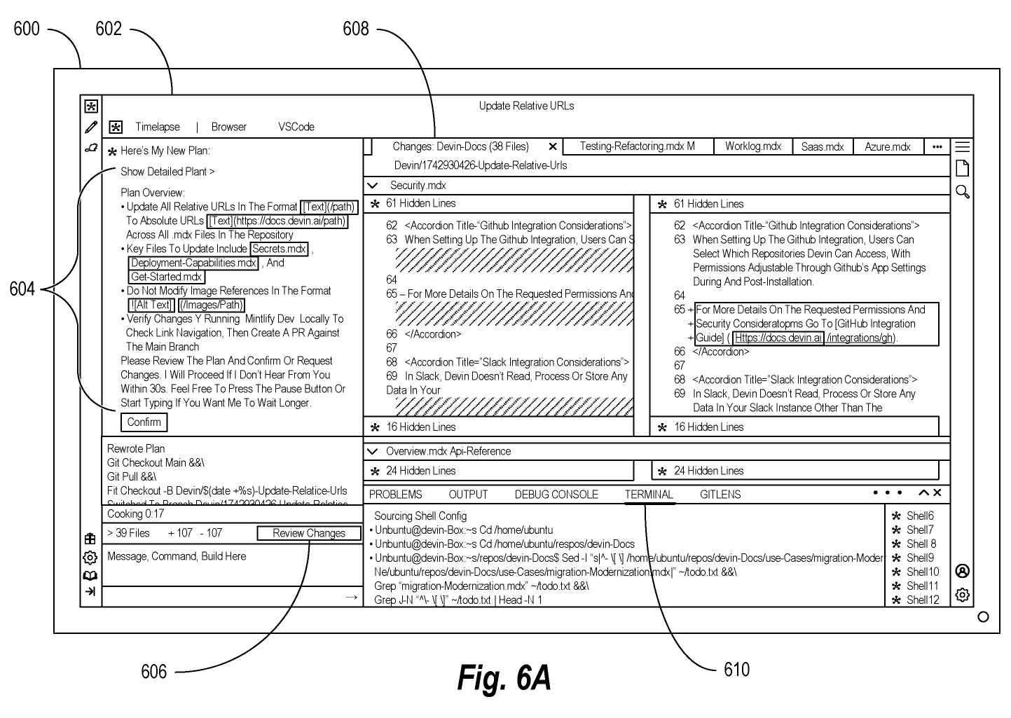

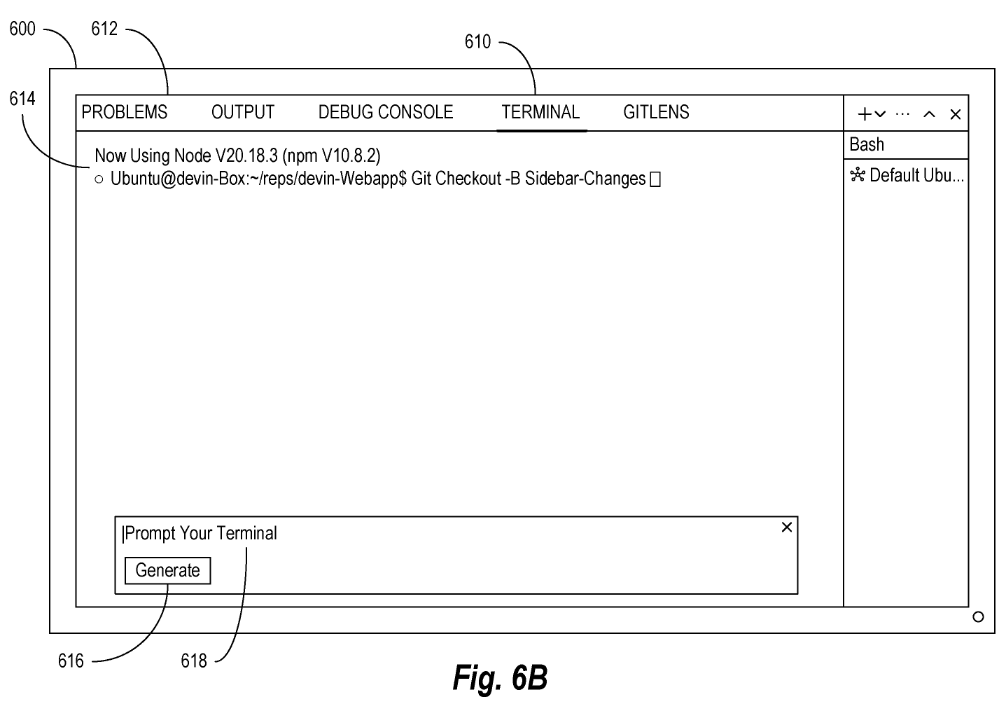

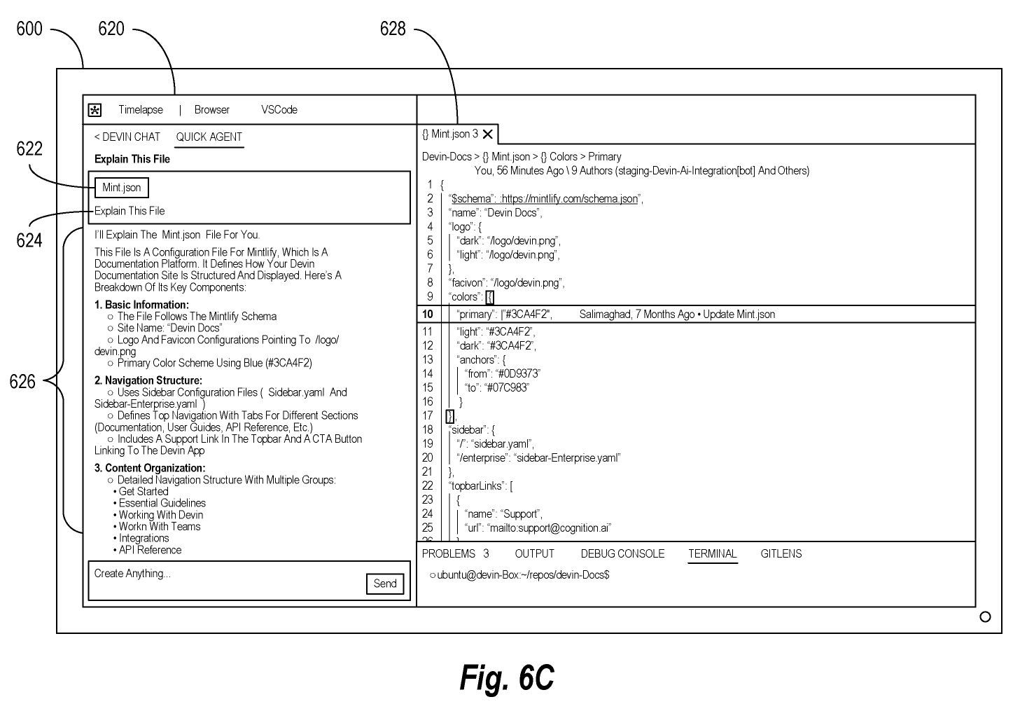

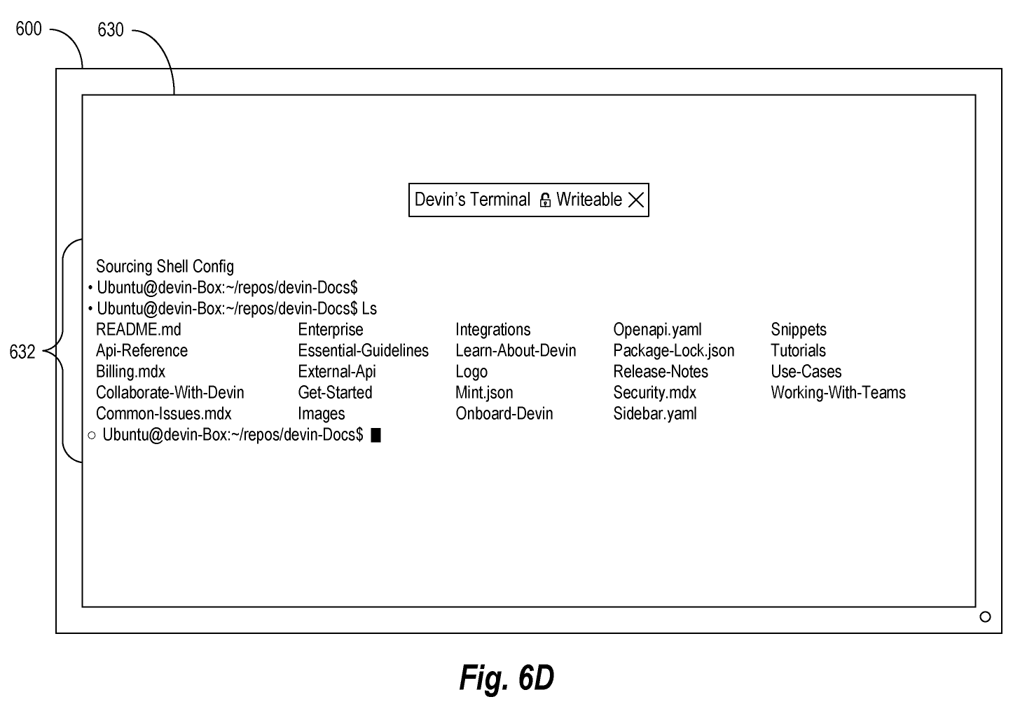

FIGS. 6A-6D illustrate example graphical user interfaces of a user computing device that displays actions taken by the autonomous software agent in accordance with one or more embodiments. In some embodiments, FIGS. 6A-6D illustrates how the autonomous software agent system 100 allows a user computing device to pair program alongside the autonomous software agent and/or intervene in the software coding task of the autonomous software agent.

FIG. 6A illustrates a graphical user interface 602 on a user computing device 600 of an IDE (integrated development environment) that allows a user computing device to make edits and test the autonomous software agent’s code directly in the autonomous software agent’s IDE (e.g., directly access Devin’s machine). In particular, FIG. 6A shows the autonomous software agent operating in an interactive IDE (e.g., interactive VSCode environment) loaded with code repositories of a centralized development platform.

For instance, FIG. 6A shows that the user computing device 600 can check in on the autonomous software agent’s edits in real time (e.g., by selecting a graphical user interface element to follow the autonomous software agent), touch up the changes, or test the autonomous software agent’s code directly using IDE tools and shortcuts.

Moreover, FIG. 6A shows that the fully featured IDE includes an editor tab 608 with multiple additional editor tabs for writing computer code for different files. In other words, FIG. 6A shows that the autonomous software agent system 100 can deploy an autonomous software agent to execute multiple software coding tasks in parallel (e.g., the autonomous software agent can open multiple tabs). Further, FIG. 6A shows how the user computing device 600 can follow (e.g., via the graphical user interface 602) the actions taken by the autonomous software agent.

As mentioned above, FIG. 6A shows the graphical user interface 602 of the user computing device 600. In one or more embodiments, the graphical user interface 602 refers to a screen of a user computing device. In other words, the graphical user interface refers to an interface that allows users to view and/or interact with a computing device.

In one or more embodiments, the graphical user interface 602 (e.g., the screen) refers to a visual part of a software application that allows a user of a computing device to interact with the software application. In particular, the autonomous software agent system 100 provides graphical user interfaces (e.g., screens) which allows a user of a computing device to interact with the software application through executable elements (e.g., buttons, menus, drop-downs, scrolling, icons, windows).

In some embodiments, the autonomous software agent system 100 enables a user of a computing device to interact directly with a software application using a mouse, touchpad or touchscreen to select executable elements shown on a graphical user interface screen. In particular, the graphical user interface 602 can include visual elements such as icons (e.g., small pictures to represent programs), buttons (e.g., clickable elements), windows (e.g., displays content), menus (e.g., list of options or commands), text boxes, etc.

In some embodiments, the “graphical user interface on the user computing device” refers to the screen of the user computing device 600 (e.g., which a user can interact with via the user computing device). In particular, the graphical user interface 602 on the user computing device 600 can follow the autonomous software agent while it is writing computer code. For example, the graphical user interface 602 on the user computing device 600 can display the actions of the autonomous software agent by showing the integrated development environment of the autonomous software agent. In one or more embodiments, the graphical user interface 602 on the user computing device 600 shows actions taken by the autonomous software agent such as submitting terminal commands, using an editor to write computer code, accessing project files, compiling executable program code, etc.

In some embodiments, a command refers to text-based instructions submitted/inputted into a terminal 610 (e.g., the terminal is an interface that allows computing devices such as the user computing device and/or the autonomous software agent to interact with a computer system’s underlying operating system or run scripts and programs directly) within the integrated development environment to perform various tasks. For example, commands can include compiling code (e.g., compile source code into an executable file), running programs (e.g., running a compiled program), version control (e.g., committing changes, pulling updates, branching, etc.), managing files (e.g., navigate a file system, create new files, modify existing files, etc.), installing dependencies (e.g., installing code libraries), running tests (e.g., unit testing), etc.

As mentioned above, the autonomous software agent has access to its own editor. In some embodiments, an editor refers to a software program or tool for writing or modifying computer code. In particular, an editor streamlines a computer code writing process by providing syntax highlighting, auto-completion, and error detection. For example, the editor provides color-coding for keywords, variables, functions, and other code elements. Further, for auto-completion, the editor suggests completions for variables, methods, classes, and functions.

In some embodiments, project files refer to a set of files and resources organized together to represent a specific software coding task (e.g., project). For example, the project files can include source code (e.g., program code written in a specific programming language), configurations (e.g., settings defining how a project is built, compiled, and executed), dependencies (e.g., external libraries), libraries, assets, and other components required to complete a software coding task.

In some embodiments, executable program code refers to a set of instructions that a computing device can directly execute. In particular, executable program code includes machine-readable instructions that result from compiling high-level programming languages. In other words, executable program code refers to a final output for a software development process created by compiling source code.

FIG. 6A shows on the graphical user interface 602 of the user computing device 600 a plan 604, which was discussed above. In particular, the plan 604 illustrates how the autonomous software agent system 100 breaks down a request to deploy an autonomous software agent to perform a software coding task. As mentioned above, in some embodiments, the autonomous software agent system 100 utilizes a chain-of-thought reasoning model to break down a meta task (e.g., a request for a software coding task) into multiple discrete intermediate tasks. As illustrated in FIG. 6A, the plan 604 shows multiple sub steps.

To illustrate, FIG. 6A shows a plan overview of 1) update all relative URLs in the format [Text](/path) to absolute URLs [Text](https://docs.devin.ai/path) across all .mdx files in the repository, 2) key files to update include secrets.mdx, deployment-capabilities.mdx, and get-started.mdx, 3) do not modify image references in the format ![Alt Text] (/ImagesPath), and 4) verify changes Y running Mintlify dev locally to check link navigation, then create a PR against the main branch. Moreover, the autonomous software agent system 100 provides an option for the user computing device to confirm the plan.

Furthermore, FIG. 6A shows an option to review changes 606. In particular, the option to review changes 606 allows a user computing device to receive a version history comparison of files (e.g., in the centralized development platform) before deployment of the autonomous software agent and after deployment of the autonomous software agent. In some embodiments, the option to review changes 606 includes a view in the graphical user interface 602 to see a different view of file edits that the autonomous software agent has made thus far (e.g., from time point A relative to time point B).

Moreover, in some embodiments, the autonomous software agent system 100 can send citations or references to computer code. In particular, the autonomous software agent system 100 can receive input from the user computing device 600 of a portion of computer code (e.g., in the editor). In response, the autonomous software agent system 100 can return deep links (e.g., citations or references that points directly to a specific piece of content within the IDE) to the computer code within the IDE of the autonomous software agent. Thus, FIG. 6A shows how the autonomous software agent system 100 enables a user computing device to submit prompts and follow actions taken by a deployed autonomous software agent all within a unified graphical user interface.

FIG. 6B shows additional details of the terminal 610 of the fully featured IDE of the autonomous software agent in accordance with one or more embodiments. For example, FIG. 6B shows a graphical user interface 612 of the user computing device 600 which further displays the terminal 610 of the autonomous software agent. In particular, FIG. 6B shows content 614 in the terminal 610 that includes natural language instructions input into the terminal 610 (e.g., now using node v20.18.3 (npm V10.8.2). To illustrate, the autonomous software agent system 100 can receive a shortcut (e.g., command + K) from the user computing device 600 and generate terminal commands (e.g., shown in FIG. 6B) from natural language.

Moreover, FIG. 6B shows a prompt input 618 to submit a prompt the terminal 610 and further shows a generate option 616 to generate instructions based on an input prompt. Thus, FIG. 6B illustrates how the autonomous software agent system 100 enables a user computing device to intervene in the IDE of the autonomous software agent, write prompts, and submit prompts on behalf of the autonomous software agent. As mentioned above, the user intervention is extremely effective for helping push difficult software coding tasks to completion that the autonomous software agent would not normally be able to one-shot.

FIG. 6C illustrates the autonomous software agent system 100 performing native AI functions in the IDE of the autonomous software agent in accordance with one or more embodiments. For example, FIG. 6C shows a graphical user interface 620 of the user computing device 600. In particular, FIG. 6C shows an editor tab 628 with written computer code (e.g., computer code written by the autonomous software agent) and also provides an option for the user computing device 600 to query the autonomous software agent system 100 about the written computer code.

As shown in FIG. 6C, the graphical user interface 620 shows the autonomous software agent system 100 receiving a query and providing a response to the query. For instance, FIG. 6C shows a query 624 of “explain this file” for an indicated file 622 (e.g., Mint.json). Moreover, FIG. 6C shows a response 626 to the query 624.

To illustrate, the autonomous software agent system 100 generates a response of “this file is a configuration file for Mintlify, which is a documentation platform. It defines how your Devin documentation site is structured and displayed….basic information: the file follows the Mintlify schema…navigation structure: uses sidebar configuration files…content organization: detailed navigation structure with multiple groups…” Accordingly, FIG. 6C illustrates how the autonomous software agent system 100 enables a user computing device to pair program alongside the autonomous software agent to understand the context of the actions being taken by the autonomous software agent.

FIG. 6D illustrates an example of the IDE terminal of the autonomous software agent in accordance with one or more embodiments. For example, FIG. 6D shows a graphical user interface 630 of the user computing device 600 which shows content 632 that includes terminals, commands, and their outputs. In particular, FIG. 6D shows the user computing device 600 switching from read-only to writeable to run the user computing device’s own commands (e.g., intervening and taking over the autonomous software agent’s IDE).

To illustrate, FIG. 6D illustrates the user computing device 600 testing and fixing changes end to end without leaving the web application (e.g., Devin webapp) of the autonomous software agent system 100. In particular, the user computing device 600 can run an application locally, take over, and run commands. Moreover, the user computing device can further use a browser of the autonomous software agent to test a local build. Thus, FIG. 6D further illustrates how the autonomous software agent system 100 enables a user computing device to take over for the autonomous software agent to check/bolster/complete the work of the autonomous software agent.

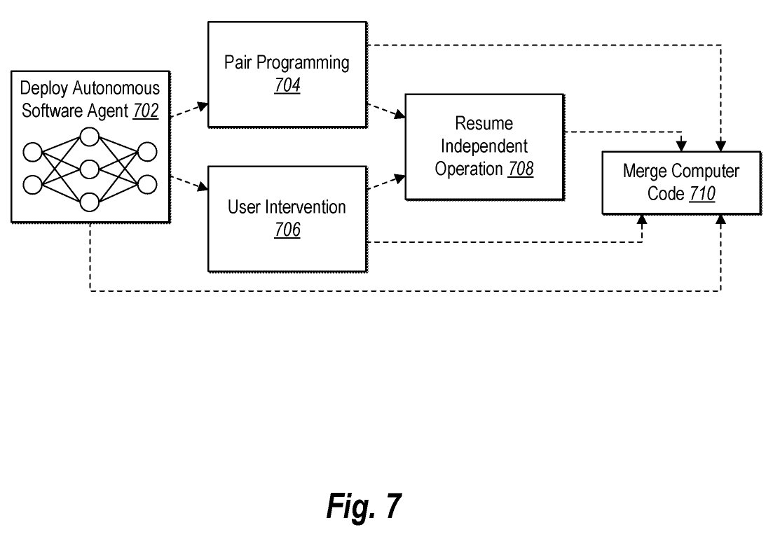

FIG. 7 illustrates an example diagram of the different autonomy levels of the autonomous software agent in accordance with one or more embodiments. For example, FIG. 7 shows the autonomous software agent system 100 deploying an autonomous software agent 702. Furthermore, in response to deploying the autonomous software agent 702, the autonomous software agent system 100 enables options for a user computing device to intervene or pair program. In particular, FIG. 7 shows an option 704 of pair programming and an option 706 of user intervention.

As is discussed above, the option 704 to pair program allows the user computing device to selectively review the work of the autonomous software agent 702 executing a software coding task. In particular, the user computing device can jump to different sections of computer code written by the autonomous software agent, add comments to computer code, leverage AI features (e.g., submit queries about already written code), etc. Moreover, in some embodiments, while a user computing device is pair programming alongside the autonomous software agent 702, the autonomous software agent system 100 can further utilize any inputs from the user computing device as context/guidance for downstream actions performed by the autonomous software agent 702.

As is also discussed above, the option 706 of user intervention allows the user computing device to pause the work of the autonomous software agent 702. For example, the user computing device can assign a software coding task to the autonomous software agent 702 that is not easy to one-shot and then intervene at an appropriate point of the software coding task. In one or more embodiments, the user computing device intervenes when the autonomous software agent 702 has completely stopped/paused a software coding task (e.g., the user computing device selects an “intervene” graphical user interface element and the autonomous software agent 702 may take a moment to wrap up). In doing so, the user computing device can avoid simultaneous, conflicting changes in the IDE of the autonomous software agent 702.

As is further shown in FIG. 7, after the option 704 of pair programming and/or the option 706 of user intervention, the autonomous software agent system 100 can further receive an indication 708 to resume independent operation. In other words, after pair programming or complete user intervention, the user computing device can cause the autonomous software agent 702 to take full control of the reins (e.g., operate fully independently) and complete a remainder of the software coding task.

In some embodiments, in parallel with receiving the indication 708 to resume independent operations, the autonomous software agent system 100 also receives input from the user computing device indicating changes that have been made by the user computing device. As mentioned above, this provides valuable context to the autonomous software agent 702 to complete a remainder of the software coding task. Moreover, in some embodiments, the input that indicates any changes made by the user computing device can further include additional instructions that modify an initial request to deploy the autonomous software agent 702.

As shown in FIG. 7, the autonomous software agent system 100 can further proceed to performing an act 710 of merging computer code. For example, the autonomous software agent system 100 can perform the act 710 of merging computer code after pair programming, after user intervention, and/or after resuming independent operation. In some embodiments, the autonomous software agent system 100 can perform the act 710 after a sub-portion of a software coding task is performed, while in some embodiments, the autonomous software agent system 100 waits until an entire software coding task is completed to perform the act 710.

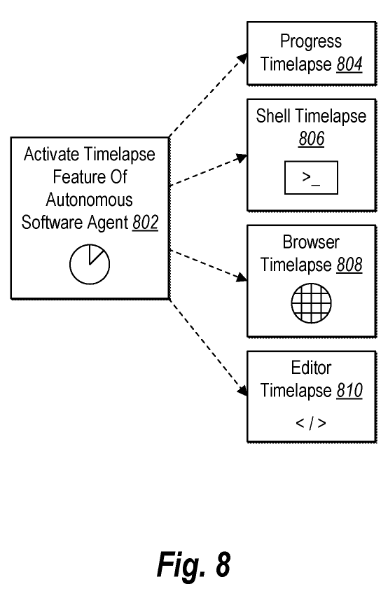

FIG. 8 illustrates an example diagram of a timelapse feature provided by the autonomous software agent system 100 in accordance with one or more embodiments. For example, FIG. 8 shows the autonomous software agent system 100 receiving an indication 802 to activate a timelapse feature of the autonomous software agent.

In some embodiments, a timelapse feature refers to an option to selectively review an IDE of an autonomous software agent across a development session, while the autonomous software agent is performing a software coding task. In particular, the timelapse feature allows a user computing device to jump to any point in time of a development session of an autonomous software agent.

For example, the timelapse feature allows the user computing device to view an abstracted version of the autonomous software agent’s work and to scrub throughout a timeline of the development session. In other words, in addition to the real-time view of an autonomous software agent’s IDE, the user computing device can also jump to any point in time of a development session to see the progress and different versions of work performed by the autonomous software agent.

In one or more embodiments, a development session refers to a work cycle of the autonomous software agent executing a software coding task. In particular, the development session refers to a starting point of the autonomous software agent system 100 receiving a request to deploy an autonomous software agent up to completion of one or more software coding tasks indicated by the request. In other words, the development session can cover an entire work cycle (e.g., deployment of the autonomous software agent to completion of a software coding task) or a partial work cycle (e.g., deployment of the autonomous software agent to a midway point).

In one or more embodiments, the autonomous software agent system 100 provides the timelapse feature as a graphical use interface element of the user computing device. In particular, in response to a selection of the timelapse feature, the autonomous software agent system 100 can then provide an option for the user computing device to toggle between different timelapse views. For example, as shown in FIG. 8, the user computing device can toggle between a progress timelapse 804, a shell timelapse 806, a browser timelapse 808, and an editor timelapse 810.

In one or more embodiments, the progress timelapse 804 refers to an overview of sequential meta-events performed by the autonomous software agent. In particular, the progress timelapse 804 shows high-level tasks executed by the autonomous software agent (e.g., the high-level tasks essentially act as summaries of the work completed by the autonomous software agent). Further, the progress timelapse 804 shows each of the meta-events performed by the autonomous software agent starting at a selected point in a development session. In other words, the progress timelapse 804 would start at a selected point in the development session and progress linearly.

In one or more embodiments, the shell timelapse 806 refers to a selective review of a command history of the autonomous software agent. In particular, the shell timelapse 806 allows the user computing device to see the commands submitted by the autonomous software agent starting at a selected point in a development session.

Moreover, in some embodiments, the browser timelapse 808 refers to a selective review of browsing history of the autonomous software agent (e.g., via a browser) starting at a selected point in a development session. Further, in some embodiments, the editor timelapse 810 refers to a history of computer code changes starting at a selected point in the development session.

FIG. 9 illustrates an example graphical user interface of a timelapse feature and a toggle to start at a selected point in accordance with one or more embodiments. For example, FIG. 9 shows a graphical user interface 902 of a user computing device 900. Moreover, FIG. 9 shows a timelapse feature 904 selected by the user computing device (e.g., as indicated by the dashed lines). Additionally, FIG. 9 illustrates a selection of a progress timelapse 906.

Moreover, FIG. 9 shows a toggle 912 that indicates a starting point for the timelapse feature. In particular, the selection of the progress timelapse 906 and the toggle 912 causes the graphical user interface 902 to display tasks 908 completed by the autonomous software agent at the starting point (e.g., indicated by the toggle 912). Furthermore, FIG. 9 shows changes 910 that indicate changes made by the autonomous software agent up to the selected starting point (e.g., indicated by the toggle 912).

As shown in FIG. 9, the autonomous software agent system 100 further provides a browser feature 914. In particular, the browser feature 914 indicates an option for the user computing device 900 to leverage an interactive browser (e.g., by selecting an interactive browser option in the graphical user interface 902) of the autonomous software agent. In some embodiments, the autonomous software agent system 100 provides an interactive browser to follow an autonomous software agent on a website as the autonomous software agent is using a browser.

Moreover, the autonomous software agent system provides functionality for a user to take control of the autonomous software agent’s browser. In other words, the browser feature 914 includes an option in addition to the timelapse feature 904 and the “follow Devin” feature. Thus, in addition to following, pair programming, and/or intervening in the IDE of the autonomous software agent, the user computing device 900 can also access/take over an interactive browser of the autonomous software agent.

In some embodiments, the autonomous software agent system 100 receives a selection of the browser feature 914 and opens/launches an interactive browser of the autonomous software agent. In particular, the autonomous software agent system 100 causes the graphical user interface 902 to show browser activity of the autonomous software agent utilizing a browser while independently performing the software coding task. Accordingly, the user computing device 900 can intervene (e.g., take over) the autonomous software agent’s browser and push a software coding task in a different direction.

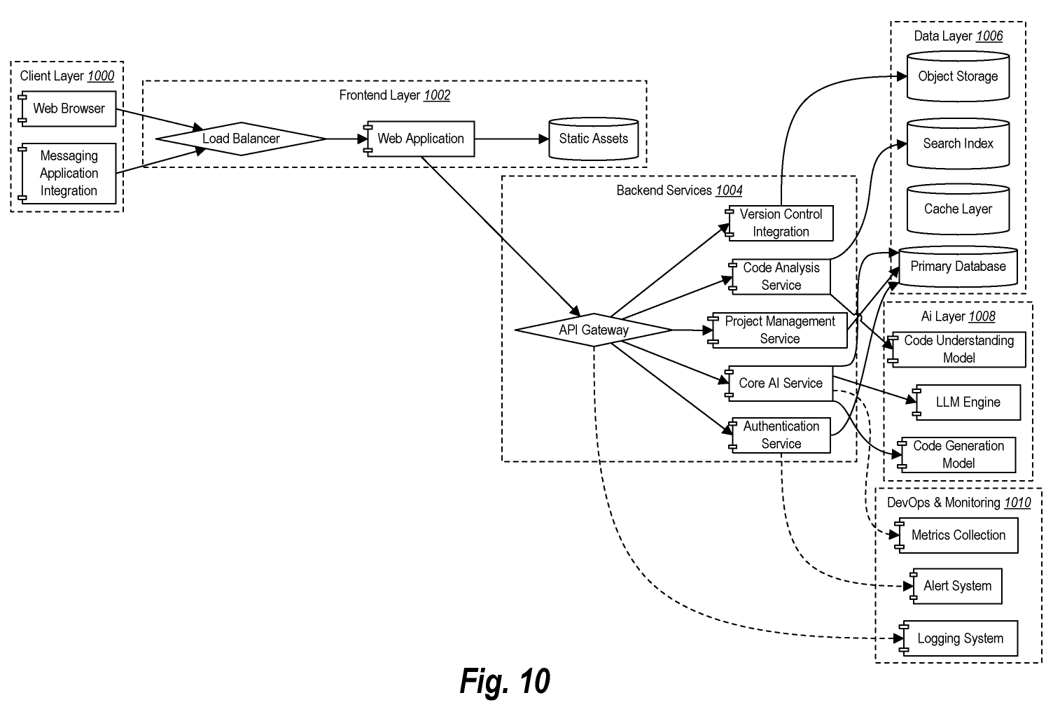

FIG. 10 illustrates architectural details of the autonomous software agent system 100 using one or more machine learning models in accordance with one or more embodiments. In particular, the autonomous software agent system 100 deploys an autonomous software agent with a fully featured IDE, generates computer code responsive to a software coding task, and provides responses to prompts submitted via an interface.

As shown in FIG. 10, the autonomous software agent system 100 contains a client layer 1000 (e.g., with a web browser, and a messaging application integration), a frontend layer 1002 (e.g., with a load balancer (e.g., a system to distribute incoming traffic across multiple servers which optimizes efficiency), a web application (e.g., Devin web application that shows the fully featured IDE of the autonomous software agent), and static assets (e.g., files that do not dynamically change based on user interactions, such as HTML files, CSS files, JavaScript files, images, etc.)).

Moreover, FIG. 10 shows the autonomous software agent system 100 also contains backend services 1004 (e.g., with an API gateway (e.g., a single entry point for managing and routing API requests from client devices to different microservices/backend systems), a version control integration (e.g., a backend service application to track changes to code such as the connected code repository application like Github), a code analysis service, a project management service (e.g., a software system to track the development of various tasks that a software development team is working on), a core AI service (e.g., artificial intelligence modules or tools to handle the use of machine learning models, natural language processing, and other artificial intelligence tasks), and an authentication service).

In particular, the backend services 1004 include applications that all communicate with the backend web-server of the autonomous software agent system 100, which performs the job of deploying autonomous software agents, and orchestrating/managing sessions (Devin sessions), as well as providing the APIs to display data about the autonomous software agent system on computing devices, providing different levels of autonomy for autonomous software agents, providing the timelapse feature, and providing the interactive browser. In particular, the backend services 1004 of the autonomous software agent system 100 manages the different levels of autonomy for a development session.

For example, the backend services 1004 performs the job of enabling pair programming and/or user intervention of the autonomous software agent. In particular, the client layer 1000, the frontend layer 1002 and the backend services 1004 are in consistent communication with one another to notify each service regarding any input received from a user computing device (e.g., during pair programming and/or user intervention). Thus, this enables the autonomous software agent system 100 to immediately transfer that input/context to a deployed autonomous software agent.

Further, FIG. 10 shows a data layer 1006 (e.g., with object storage (e.g., storage of unstructured data), search index (e.g., an index of the code repository), a cache layer (e.g., a layer that temporarily holds frequently accessed or recently computed data), a primary database (e.g., a central data store to hold application data)), an AI layer 1008 (e.g., with a code understanding model, an LLM engine, and a code generation model), and a DevOps and Monitoring layer 1010 (e.g., with metrics collection, an alert system, and a logging system).

As shown in FIG. 10, the autonomous software agent system 100 utilizes the AI layer 1008 to perform a variety of reasoning/generation tasks. In particular, the autonomous software agent system accesses the AI layer 1008 every time a code repository is connected or updated, or a new session is spun up (e.g., each time a new development box is activated). In order to enable the AI layer 1008, the autonomous software agent system 100 provides various onboarding tools to a user computing device. In particular the onboarding tools allows a user to provide access to a code repository provider (e.g., a Gitprovider), select repositories, assign read access, and assign write access.

In some embodiments, the autonomous software agent system 100 prompts a user of a computing device for additional access permissions. In particular, the autonomous software agent system 100 can prompt the user for additional access permissions after generating a response to a prompt or during an autonomous software agent session. For example, the autonomous software agent system 100 determines during generating a response or executing software coding tasks that additional knowledge/permissions are needed to more thoroughly respond/perform a task.

As further shown in FIG. 10, the AI layer 1008 of the autonomous software agent system 100 further includes a code understanding model. In particular, the code understanding model analyzes computer code. In other words, the autonomous software agent system 100 seeks to understand the context and background of a code base/repository to generate an index of the code repository (e.g., to more effectively perform software coding tasks as a driver and not merely as a co-pilot).

In some embodiments, the autonomous software agent system 100 extracts contextual data from information provided by a user to generate an index using the code understanding model. To illustrate, the autonomous software agent system 100 parses through a code repository and generate abstraction summaries using the code understanding model and one or more additional artificial intelligence models (e.g., such as the LLM engine).

Moreover, the autonomous software agent system 100 utilizes the AI layer 1008 to enable AI-native features in the IDE of the autonomous software agent. In particular, the autonomous software agent system 100 provides the AI-native features as options for a user computing device to activate during pair programming and/or during user intervention. Furthermore, autonomous software agent system 100 utilizes the AI layer 1008 to generate the timelapse feature/view for the user computing device. Essentially, the autonomous software agent system 100 processes a development session and creates the option for the user computing device to selectively review the session.

In some embodiments, the autonomous software agent system 100 uses the AI layer 1008 to ingest data from a code base and further utilizes the code understanding model to generate output predictions related to context of the code base. For example, the autonomous software agent system 100 connects to code repositories and creates knowledge inputs/suggestions based on processing the information in the code repository.

To illustrate, the autonomous software agent system 100 can read through documentation/specifications and then distills that information into data that is relevant for the code understanding model of the autonomous software agent system 100. In addition, after generating the index of the code repository, the autonomous software agent system 100 further stores the index in the data layer 1006 and/or uses the DevOps and Monitoring layer 1010 to monitor changes/thresholds related to the connected code repository. This allows the autonomous software agent system 100 to more effectively execute software coding tasks when deploying an autonomous software agent.

Moreover, after generating the index of the code repository, the autonomous software agent system 100 further generates response to prompts. In some embodiments, the autonomous software agent system 100 receives prompts from the frontend layer 1002 submitted via an interface (or where the autonomous software agent system 100 intakes prompt, whether via the web application, a messaging application, or otherwise) and are sent to the backend services 1004 of the autonomous software agent system 100, where the prompt is processed by the one or more artificial intelligence components (e.g., Devin’s brain).

As shown in FIG. 10, the autonomous software agent system 100 utilizes the client layer 1000 to receive interactions. In particular, users can submit a prompt of a question regarding a current development session, past development session, a code repository, etc. via a Devin Messaging Application Integration, an application programming interface call, or directly through a web browser application of the intelligent search interface. In some embodiments, the messaging application integration lets users prompt the autonomous software agent system 100 and to further create sessions by tagging a Devin Slackbot in their team’s messaging server.

In some embodiments, as shown, the autonomous software agent system 100 utilizes an LLM engine (e.g., a model that selects one or more large language models according to certain parameters/requirements) of an autonomous software agent to generate a response to a prompt. In particular, the autonomous software agent system 100 calls a first large language model for a first task (e.g., generating a first result for a prompt) and a second large language model for a second task (generating a second result for the prompt).

In one or more embodiments, the autonomous software agent system 100 utilizes the complex architectural design shown in FIG. 10. In particular, the autonomous software agent system 100 includes a natural language processing component (e.g., Devin’s Brain) that allows the autonomous software agent system 100 to understand natural language descriptions (e.g., the functionalities of desired software programs). In some embodiments, the autonomous software agent system 100 utilizes natural language processing to analyze natural language descriptions in a prompt and to extract key functionalities and requirements.

In one or more embodiments, the autonomous software agent system 100 generates an index of a code repository (e.g., accessible by an autonomous software agent) as described in Application No. 19/224,222 PROVIDING INTELLIGENT SEARCH FUNCTIONALITY OF A CODE REPOSITORY VIA AN AUTONOMOUS SOFTWARE AGENT which was filed on May 30^{th}, 2025, and is fully incorporated by reference herein.

As mentioned above, in some embodiments, the autonomous software agent system 100 generates a response to the prompt and uses the context from the response to deploy an autonomous software agent. In some embodiments, the autonomous software agent system 100 uses the autonomous software agent system 100 to spin up a development box, where each spun up development box contains knowledge and the autonomous software agent system from one session to another does not transfer the knowledge over to the next session.

In some embodiments, knowledge is a form of “memory” that allows the autonomous software agent system 100 to retrieve information based on specific triggers that might be relevant to the session. As also mentioned, this knowledge (depending on the trigger) is retrievable across all sessions.

As mentioned above, the autonomous software agent system 100 uses the autonomous software agent system 100 which deploys autonomous software agents that have access to their own machines. In particular, for each new spun up session, the autonomous software agent system 100 spins up a new development box (e.g., sandbox) which includes a fully featured IDE (shell, an editor, a bowser, etc.). Moreover, the autonomous software agent system 100 allows a development box to be customized in a user’s workspace (e.g., Devin’s Workspace), where the user can save a specific machine snapshot that Devin will use each time it spins up a new development box.

Furthermore, the autonomous software agent system generates development boxes that are isolated virtual machines. In particular, the development boxes run on top of a custom hypervisor implemented to support the virtual machine technology. Moreover, the state of a run (e.g., deploying an autonomous software agent) can be rolled-back to an earlier point in time. In running back to an earlier point in time, the autonomous software agent system 100 rolls back both the state of “Devin’s brain” (e.g., the knowledge and the progress on a certain task), as well as the state of Devin’s machine (e.g., the machine contents).

Moreover, in some embodiments, the autonomous software agent system 100 offers a virtual private cloud (VPC) deployment solution that allows development boxes to run within a customer’s (a set of users) cloud tenant with the “Devin brain” (e.g., a component of the autonomous software agent) interacting with the development boxes over a secure tunnel. All data related to sessions are stored at rest in the customer cloud tenant.

Furthermore, each of these development boxes (or sessions) can speak to the customer-hosted services (connected via API integrations). Accordingly, the autonomous software agent system 100 can leverage the AI layer 1008, the data layer 1006, the backend services 1004, and the frontend layer 1002 to cause the graphical user interface on the user computing device to display the actions taken by the autonomous software agent (e.g., the actions via the IDE of the autonomous software agent).

Further, as already mentioned, the autonomous software agent system 100 includes machine learning models. In particular, the autonomous software agent system 100 utilizes pre-trained machine learning models to translate descriptions (e.g., from a response to a prompt) into computer code. Moreover, the machine learning models utilized by the autonomous software agent system 100 have been trained on vast amounts of computer code data, which allows them to identify patterns and generate functional code. In some embodiments, the autonomous software agent system 100 utilizes the machine learning models to process the extracted information (e.g., key functionalities and requirements). In particular, the autonomous software agent system 100 utilizes the machine learning models to search for patterns and identify similar code structures from their training data.

Additionally, the autonomous software agent system 100 includes a code generation engine. In particular, based on processed information from the natural language processing and the machine learning models, the autonomous software agent system 100 translates the descriptions into actual computer code. In other words, the output of the natural language processing and the machine learning model is pulled into the code generation engine to create viable computer code. In some embodiments, based on identified patterns, the autonomous software agent system 100 utilizes the code generation engine to create functional code responsive to deploying an autonomous software agent after generating a response to a prompt.

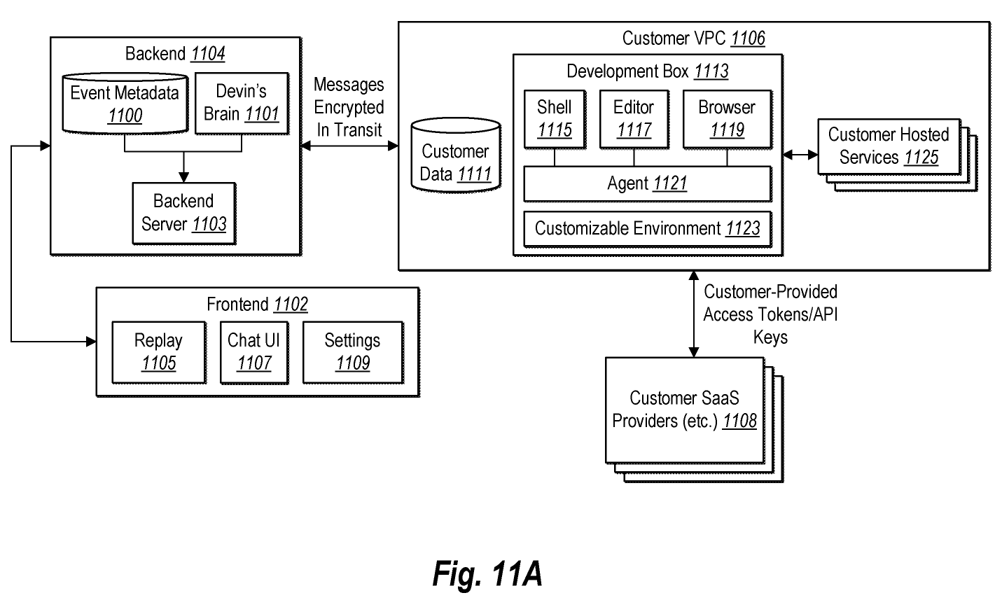

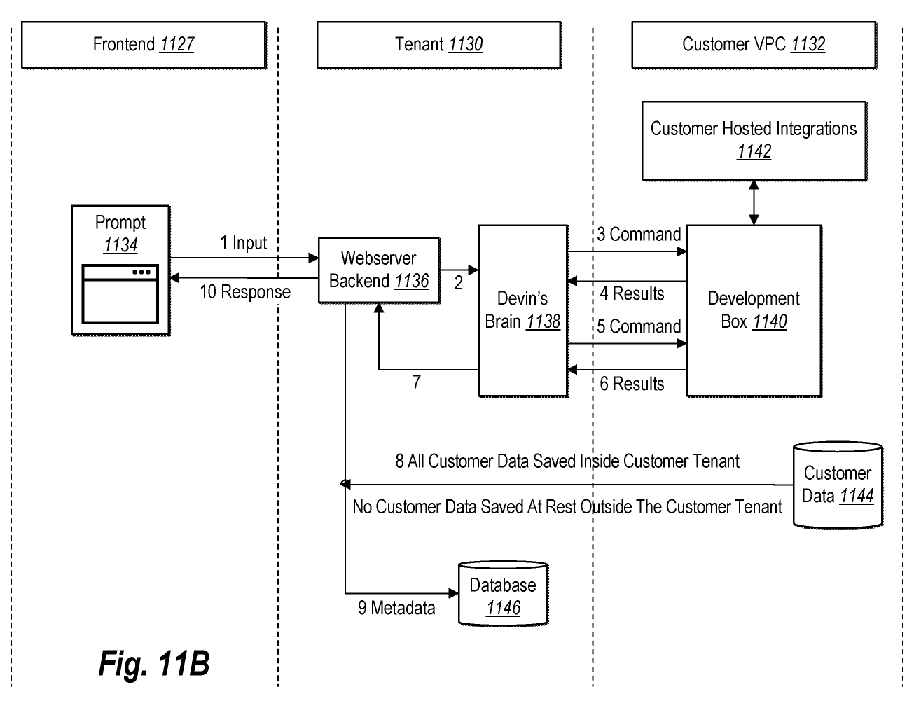

FIGS. 11A-11B illustrates additional details of the architecture of the autonomous software agent system 100 in accordance with one or more embodiments. For example, FIG. 11A shows that for each session of deploying an autonomous software agent, the autonomous software agent system 100 spins up/deploys a Backend 1104 that includes a “Devin brain container” paired with “Devin’s development box” virtual machine. As mentioned above, Devin’s Brain (e.g., the backend components of the autonomous software agent system 100) contains one or more machine learning/artificial intelligence models shown above in FIG. 10 used to process, analyze, and generate data.

As shown in FIG. 11A, the backend 1104 includes event metadata 1100 (e.g., context surrounding a prompt submitted to a web application interface, a response to the prompt, or other external sources that contain contextual data), Devin’s Brain 1101 (e.g., one or more machine learning models shown and discussed in FIG. 10), and a backend server 1103 (e.g., a server that handles logic, database interactions, authentication, and other services for deploying an autonomous software agent).

Further, FIG. 11A shows the backend interacting with a frontend 1102 which includes replay 1105 (e.g., replay for a timelapse of a development session, a session replay that is a recording of previous user interactions with the autonomous software agent system 100), Chat UI 1107 (e.g., the graphical user interface provided to a user to submit prompts), and settings 1109 (e.g., custom settings established by the autonomous software agent system 100 or by a user).

Moreover, the backend 1104 communicates with a Customer VPC 1106 (e.g., a customer virtual private cloud, which is a dedicated and isolated virtual network within a public cloud service) via encrypted messages. In particular, FIG. 11A shows a development box 1113 hosted on the Customer VPC 1106 and the Customer VPC 1106 further includes customer data 1111.

Additionally, the development box 1113 further includes a shell 1115, an editor 1117, a browser 1119, an agent 1121 (e.g., autonomous software agent), a customizable environment 1123 (e.g., playbooks, knowledge, etc.) and customer hosted services 1125 (e.g., services or applications hosted and managed by a tenant organization). Additionally, FIG. 11A shows that the Customer VPC 1106 can integrate various applications via access tokens/API keys. In particular, the autonomous software agent system can use the development box 1113 (e.g., the autonomous software agent) to write various code and make integrations with applications integrated with the Customer VPC 1106 (e.g., customer SaaS providers 1108).

Further, FIG. 11B shows that the autonomous software agent system 100 receives a prompt 1134 via a frontend 1127. In response to the prompt 1134, the autonomous software agent system 100 responds to the prompt 1134 with a webserver backend 1136 and further pass the information to Devin’s Brain 1138 (e.g., one or more artificial intelligence models shown above in FIG. 10).

As further shown in FIG. 11B, the autonomous software agent system 100 passes commands/results back and forth between a Customer VPC 1132 (e.g., a development box 1140) and Devin’s Brain 1138. In other words, FIG. 11B illustrates the interaction between the frontend 1127 of the autonomous software agent system 100, the backend of the autonomous software agent system 100, and an autonomous software agent deployed for performing tasks at the Customer VPC 1132. Furthermore, the development box 1140 also accesses customer hosted integrations 1142 at the Customer VPC 1132.

Additionally, FIG. 11B shows customer data 1144 at the Customer VPC 1132 which the autonomous software agent system 100 passes all customer data saved inside customer tenant to the tenant 1130 (e.g., and no customer data is saved at rest outside the customer tenant). Moreover, FIG. 11B shows the autonomous software agent system 100 using the webserver backend 1136 to pass metadata to a database 1146.

In one or more embodiments, the autonomous software agent system 100 receives an autonomous software agent prompt and deploys an autonomous software agent, which includes one or more machine learning components (e.g., large language models). In one or more embodiments, the autonomous software agent system 100 utilizes a text encoder to generate a set of text tokens for the autonomous software agent prompt.

Moreover, based on the text tokens, the autonomous software agent system 100 generates a plan (e.g., breaks down the software task), and further reasons how to complete one or more tasks. In particular, the autonomous software agent system uses the development box 1140 to communicate with Devin’s Brain 1138 (e.g., the artificial intelligence components shown in FIG. 10) to determine which shell commands to make, computer code to write (e.g., in the editor), and webpages to browse.

In one or more embodiments, the autonomous software agent system 100 further utilizes a text encoder to process a prompt to deploy an autonomous software agent. In particular, the text encoder includes a component of a neural network to transform textual data (e.g., the text prompt) into a numerical representation. For instance, the autonomous software agent system 100 utilizes the text encoder to transform the prompt into a text encoding (e.g., text tokens). Further, the autonomous software agent system 100 utilizes the text encoder in a variety of ways.

For instance, the autonomous software agent system 100 utilizes the text encoder to i) determine the frequency of individual words in the text prompt (e.g., each word becomes a feature vector), ii) determines a weight for each word within the text prompt to generate a text vector that captures the importance of words within a text prompt, iii) generates low-dimensional text vectors in a continuous vector space that represents words within the text prompt, and/or iv) generates contextualized text vectors by determining semantic relationships between words within the text prompt.

Furthermore, although not shown in FIGS. 10 and 11A-11B, in one or more embodiments, the autonomous software agent system trains Devin’s Brain 1138 (e.g., artificial intelligence components such as the code generation engine, the natural language processing, and the machine learning models). For example, the autonomous software agent system 100 leverages a set of large language models and fine-tunes each large language model for different tasks. In particular, the autonomous software agent system 100 has a large language model for terminal requests, a large language model for generating computer code, a large language model for generating a plan, and a large language model for determining which webpages to browse.

Moreover, the autonomous software agent system 100 trains Devin’s Brain 1138 by sending an input task to one or more of the large language models, generates a prediction for the input task, and compares the prediction with a ground truth reference. Based on the comparison, the autonomous software agent system 100 fine-tunes or modifies parameters of one or more large language models (e.g., that are part of Devin’s Brain). Thus, at inference time, the autonomous software agent system 100 performs advanced reasoning tasks fine-tuned for specific use cases.

In addition, as alluded to above, the autonomous software agent system trains machine learning models to translate descriptions into code. In some embodiments, the autonomous software agent system 100 trains multiple machine learning models for discrete tasks. In particular, the autonomous software agent system 100 trains a machine learning model to generate specific types of functional code. For example, the autonomous software agent system 100 utilizes a machine learning model to generate computer code from a description and compares the description to a ground truth reference and fine-tunes/modifies parameters of the machine learning model.

Moreover, the autonomous software agent system 100 further continuously learns from feedback and developer interactions. In particular, the autonomous software agent system 100 deploys autonomous software agents that perform a variety of tasks, and in response to prompts and/or feedback (e.g., pair programming and/or user intervention), the autonomous software agent system 100 learns from the interactions to improve its capabilities. In other words, the autonomous software agent system 100 fine-tunes the artificial intelligence components in response to updates/feedback received from users.

FIGS. 11A-11B describe various architectural details of the autonomous software agent system 100. In particular, the architectural components of the autonomous software agent system 100 enables an autonomous software agent to perform a variety of tasks. To illustrate, the autonomous software agent system 100 performs repetitive coding tasks such as generating boilerplate code, data validation routines, and unit tests.

Moreover, the autonomous software agent system 100 performs code revies (e.g., one or more software developers examine code written by others to identify potential issues and provide feedback) and debugging such as analyzing code to identify potential bugs and suggesting fixes/improvements. Furthermore, the autonomous software agent system 100 performs deployment automation to automate a deployment process of software (e.g., streamlining the transition from development to production).

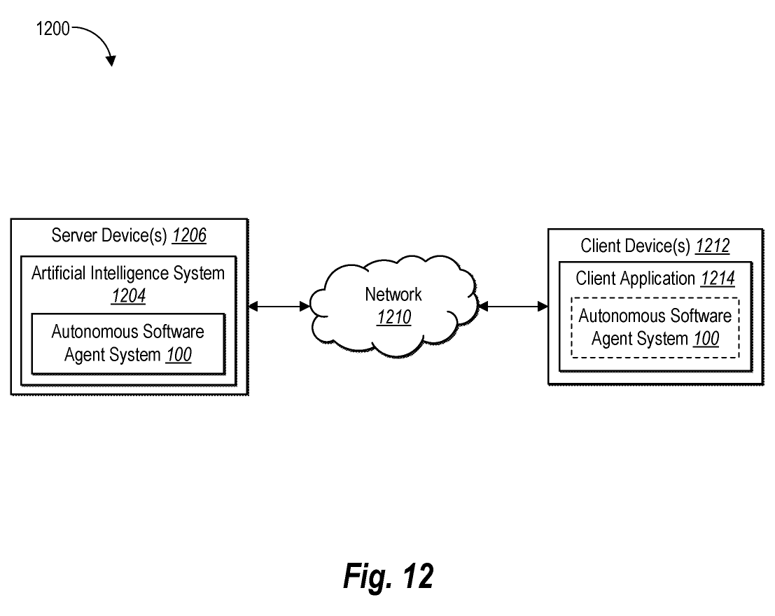

Additional details regarding the autonomous software agent system 100 will now be provided with reference to the figures. For example, FIG. 12 illustrates a schematic diagram of an exemplary system environment 1200 in which an autonomous software agent system 100 operates. As illustrated in FIG. 1, the system environment 1200 includes server device(s) 1206, an artificial intelligence system 1204, a network 1210, and client device(s) 1212. Additionally, FIG. 1 illustrates that the artificial intelligence system 1204 includes the autonomous software agent system 100.

Although the system environment 1200 of FIG. 1 is depicted as having a particular number of components, the system environment 1200 is capable of having a different number of additional or alternative components (e.g., a different number of servers, client devices, or other components in communication with the autonomous software agent system 100 via the network 1210). Similarly, although FIG. 1 illustrates a particular arrangement of the server device(s) 1206, the network 1210, and the client device(s) 1212, various additional arrangements are possible.

The server device(s) 1206, the network 1210, and the client device(s) 1212 are communicatively coupled with each other either directly or indirectly (e.g., through the network 1210 discussed in greater detail below). Moreover, the server device(s) 1206 and the client device(s) 1212 include one or more of a variety of computing devices (including one or more computing devices as discussed in greater detail below).

As mentioned above, the system environment 1200 includes the server device(s) 1206. In one or more embodiments, the server device(s) 1206 process input for a request (e.g., a request to configure an autonomous software agent or to deploy an autonomous software agent). In one or more embodiments, the server device(s) 1206 comprise a data server. In some implementations, the server device(s) 1206 comprise a communication server or a web-hosting server. Furthermore, the server device(s) 1206 can be associated with the autonomous software agent system 100 or with an organization/company that deploys the autonomous software agent system 100.

In some embodiments, the client device(s) 1212 includes computing devices associated with the one or more user accounts that submit requests for the autonomous software agent system 100. In some embodiments, the autonomous software agent system 100 trains one or more artificial intelligence models such as a code understanding model, one or more large language models, and a code generation model.

In one or more embodiments, the client device(s) 1212 includes smartphones, tablets, desktop computers, laptop computers, head-mounted-display devices, or other electronic devices. The client device(s) 1212 includes one or more software applications (e.g., the client application 1214) for generating content in accordance with the artificial intelligence system 1204. In one or more embodiments, the client application 1214 includes a software application hosted on the server device(s) 1206 accessible by the client device(s) 1212 through another application, such as a web browser.

To provide an example implementation, in some embodiments, the autonomous software agent system 100 on the server device(s) 1206 supports the autonomous software agent system 100 on the client device(s) 1212. For instance, in some cases, the artificial intelligence system 1204 on the server device(s) 1206 gathers data for the autonomous software agent system 100. In response, the autonomous software agent system 100, via the server device(s) 1206, provides the information to the client device(s) 1212. In other words, the client device(s) 1212 obtains (e.g., downloads) the autonomous software agent system 100 from the server device(s) 1206 that is already trained/optimized. Once downloaded, the autonomous software agent system 100 on the client device(s) 1212 is able to perform tasks (e.g., generative software tasks) independent from the server device(s) 1206. In one or more alternative implementations, the autonomous software agent system 100 generates or learns parameters for one or more artificial intelligence models (e.g., used to implement an autonomous software agent) in whole or in part on the client device(s) 1212.

In alternative implementations, the artificial intelligence system 1204 includes a web hosting application that allows the client device(s) 1212 to interact with content and services hosted on the server device(s) 1206. To illustrate, in one or more implementations, the client device(s) 1212 accesses a software application supported by the server device(s) 1206. In response, the artificial intelligence system 1204 on the server device(s) 1206 provides tools for monitoring/modifying/generating computer code using the autonomous software agent. In other words, the client device(s) 1212 does not have to download the autonomous software agent system 100 while still being able to access/utilize the trained/optimized tools provided by the artificial intelligence system 1204 via a web hosting application.

In some embodiments, the autonomous software agent system 100 is implemented in whole, or in part, by the individual elements of the system environment 1200. For instance, although FIG. 1 illustrates the autonomous software agent system 100 implemented or hosted on the server device(s) 1206, different components of the autonomous software agent system 100 are able to be implemented by a variety of devices within the system environment 1200. For example, one or more (or all) components of the autonomous software agent system 100 are implemented by a different computing device or a separate server from the server device(s) 1206. Indeed, as shown in FIG. 1, the client device(s) 1212 includes the autonomous software agent system 100.

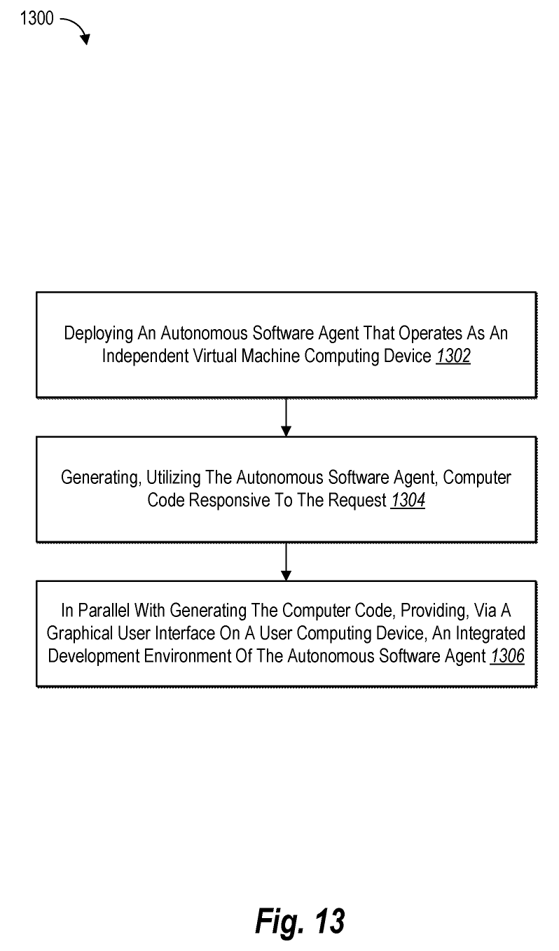

FIG. 13 illustrates a flowchart of a series of acts 1300 for generating a response to a prompt to search a code repository in accordance with one or more embodiments. FIG. 13 illustrates acts according to one embodiment, alternative embodiments may omit, add to, reorder, and/or modify any of the acts shown in FIG. 13. In some implementations, the acts of FIG. 13 are performed as part of a method. For example, in some embodiments, the acts of FIG. 13 are performed as part of a computer-implemented method. Alternatively, a non-transitory computer-readable medium stores instructions thereon that, when executed by at least one processor, cause a computing device to perform the acts of FIG. 13. In some embodiments, a system performs the acts of FIG. 13. For example, in one or more embodiments, a system includes at least one memory device. The system further includes at least one server device configured to cause the system to perform the acts of FIG. 13.

The series of acts 1300 includes an act 1302 of deploying an autonomous software agent that operates as an independent virtual machine computing device. Further, the series of acts 1300 includes an act 1304 of generating, utilizing the autonomous software agent, computer code responsive to the request. Moreover, the series of acts 1300 includes an act 1306 of in parallel with generating the computer code, providing, via a graphical user interface on a user computing device, an integrated development environment of the autonomous software agent.

In particular, the act 1302 includes in response to a request to activate an autonomous software agent to perform a software coding task, deploying the autonomous software agent that operates as an independent virtual machine computing device. Further, the act 1304 includes generating, utilizing the autonomous software agent to perform the software coding task in an integrated development environment of the autonomous software agent, computer code responsive to the request. Moreover, the act 1306 includes in parallel with generating the computer code, providing, via a graphical user interface on a user computing device, the integrated development environment of the autonomous software agent, wherein the graphical user interface displays actions taken by the autonomous software agent while independently performing the software coding task.

In one or more embodiments, the series of acts 1300 includes the actions comprising commands submitted by the autonomous software agent via a terminal while performing the software coding task. In addition, in one or more embodiments, the series of acts 1300 includes computer code being written by the autonomous software agent via an editor while performing the software coding task. In one or more embodiments, the series of acts 1300 includes computer code being debugged by the autonomous software agent while performing the software coding task.

Further, in one or more embodiments, the series of acts 1300 includes providing one or more options to switch between different levels of autonomy for the autonomous software agent. Further, in some embodiments, the series of acts 1300 includes providing an option for the user computing device to perform pair programming with the autonomous software agent, wherein pair programming includes the user computing device submitting inputs to guide the autonomous software agent. In one or more embodiments, the series of acts 1300 includes providing an additional option for the user computing device to intervene in the integrated development environment of the autonomous software agent to cause the autonomous software agent to stop performing the software coding task.

Moreover, in one or more embodiments, the series of acts 1300 includes receiving a selection from the user computing device of the additional option to intervene in the integrated development environment. Further, in some embodiments, the series of acts 1300 includes receiving user computer code from the user computing device via the integrated development environment of the autonomous software agent.

Further, in one or more embodiments, the series of acts 1300 includes receiving an indication from the user computing device for the autonomous software agent to resume performing the software coding task based on the user computer code received from the user computing device. Moreover, in one or more embodiments, the series of acts 1300 includes generating, utilizing the autonomous software agent, additional computer code to complete the software coding task. Further, in one or more embodiments, the series of acts 1300 includes accessing, via the autonomous software agent, one or more code repositories that are accessible to the user computing device. In one or more embodiments, the series of acts 1300 includes generating the computer code to add to existing computer code in the one or more code repositories or to modify the existing computer code in the one or more code repositories.

Further, in one or more embodiments, the series of acts 1300 includes providing, via the graphical user interface on the user computing device, a timelapse feature to selectively review the integrated development environment of the autonomous software agent when performing the software coding task. Moreover, in one or more embodiments, the series of acts 1300 includes receiving a selection from the user computing device of the timelapse feature at an indicated point of a development session of the autonomous software agent. In some embodiments, the series of acts 1300 includes providing, via the graphical user interface on the user computing device, the integrated development environment, wherein the graphical user interface displays actions taken by the autonomous software agent starting at the indicated point of the development session.

Additionally, in one or more embodiments, the series of acts 1300 includes in response to a request to activate an autonomous software agent to perform a software coding task, deploying the autonomous software agent that operates as an independent virtual machine computing device. Further, in some embodiments, the series of acts 1300 includes generating, utilizing the autonomous software agent to perform the software coding task in an integrated development environment of the autonomous software agent, computer code responsive to the request. In one or more embodiments, the series of acts 1300 includes providing, via a graphical user interface on a user computing device, the integrated development environment of the autonomous software agent, wherein the graphical user interface displays actions taken by the autonomous software agent while independently performing the software coding task. Moreover, in one or more embodiments, series of acts 1300 includes providing, via the graphical user interface, one or more options to perform pair programming with the autonomous software agent via the integrated development environment or to intervene in the integrated development environment and cause the autonomous software agent to stop performing the software coding task.

In one or more embodiments, the series of acts 1300 includes accessing, via the autonomous software agent, one or more code repositories that are accessed by the user computing device, wherein the one or more code repositories are part of a centralized development platform for one or more user computing devices. In one or more embodiments, the series of acts 1300 includes deploying the autonomous software agent to perform the software coding task by utilizing the one or more code repositories as context for generating the computer code responsive to the request.

In addition, in one or more embodiments, the series of acts 1300 includes the actions comprise computer code being written by the autonomous software agent via an editor while performing the software coding task. Further, in one or more embodiments, the series of acts 1300 includes computer code in a code repository being edited by the autonomous software agent while performing the software coding task. Further, in some embodiments, the series of acts 1300 includes project files accessed by the autonomous software agent from one or more code repositories. In some embodiments, the series of acts 1300 includes computer code being converted into executable program code by the autonomous software agent via a compiler.

Moreover, in some embodiments, the series of acts 1300 includes providing an option, via the graphical user interface, to follow the autonomous software agent performing the software coding task. In one or more embodiments, the series of acts 1300 includes receiving a selection of the option from the user computing device to follow the autonomous software agent. Furthermore, in one or more embodiments, the series of acts 1300 includes in response to the selection of the option from the user computing device, providing, via the graphical user interface, the actions taken by the autonomous software agent while independently performing the software coding task.

Moreover, in one or more embodiments, the series of acts 1300 includes providing different levels of autonomy for the autonomous software agent comprising an option for the user computing device to perform pair programming with the autonomous software agent, wherein pair programming includes the user computing device submitting inputs to guide the autonomous software agent. Moreover, in some embodiments, the series of acts 1300 includes an additional option for the user computing device to intervene in the integrated development environment of the autonomous software agent for the user computing device to add to or modify the computer code written by the autonomous software agent in the integrated development environment.

In one or more embodiments, the series of acts 1300 includes receiving a selection of the option to perform pair programming with the autonomous software agent. Furthermore, in one or more embodiments, the series of acts 1300 includes during pair programming, providing a plurality of shortcuts for the user computing device to submit via the integrated development environment. Moreover, in one or more embodiments, the series of acts 1300 includes wherein the plurality of shortcuts comprises adding comments, collapsing code blocks in the integrated development environment, navigating files in the integrated development environment, and triggering computer code completions in the integrated development environment.

In one or more embodiments, the series of acts 1300 includes receiving a selection of the additional option to intervene in the integrated development environment of the autonomous software agent. In one or more embodiments, the series of acts 1300 includes pause the autonomous software agent from performing the software coding task. In one or more embodiments, the series of acts 1300 includes receiving, via the integrated development environment of the autonomous software agent, user computer code from the user computer device. In one or more embodiments, the series of acts 1300 includes receiving an indication from the user computing device for the autonomous software agent to independently resume performing the software coding task based on the user computer code from the user computer device.

In one or more embodiments, the series of acts 1300 includes in response to a request to activate an autonomous software agent to perform a software coding task, deploying the autonomous software agent that operates as an independent virtual machine computing device. In one or more embodiments, the series of acts 1300 includes generating, utilizing the autonomous software agent to perform the software coding task in an integrated development environment of the autonomous software agent, computer code responsive to the request. In one or more embodiments, the series of acts 1300 includes providing, via a graphical user interface on a user computing device, the integrated development environment of the autonomous software agent and a timelapse feature to selectively review the integrated development environment of the autonomous software agent across a development session of the autonomous software agent when performing the software coding task.

Moreover, in some embodiments, the series of acts 1300 includes providing a toggle element, via the graphical user interface, for the user computing device to indicate a specific point in the development session of the autonomous software agent executing the software coding task. Further, in some embodiments, the series of acts 1300 includes providing as part of the timelapse feature a progress tab, a shell tab, a browser tab, and an editor tab for the user computing device.

Moreover, in some embodiments, the series of acts 1300 includes providing the progress tab comprises providing an overview of sequential meta-events performed by the autonomous software agent starting at a selected point in the development session. Additionally, in some embodiments, the series of acts 1300 includes providing the shell tab comprises providing command history of the autonomous software agent starting at the selected point in the development session.

Moreover, in some embodiments, the series of acts 1300 includes providing the browser tab comprises providing a browsing history of the autonomous software agent starting at a selected point in the development session. Furthermore, in some embodiments, the series of acts 1300 includes providing the editor tab comprises providing a history of computer code changes starting at the selected point in the development session.

Moreover, in some embodiments, the series of acts 1300 includes providing an interactive browser option via the graphical user interface of the user computing device. In some embodiments, the series of acts 1300 includes receiving, via the graphical user interface, a selection of the interactive browser option. In some embodiments, the series of acts 1300 includes providing, via the graphical user interface on the user computing device, browser activity of the autonomous software agent utilizing a browser while independently performing the software coding task.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

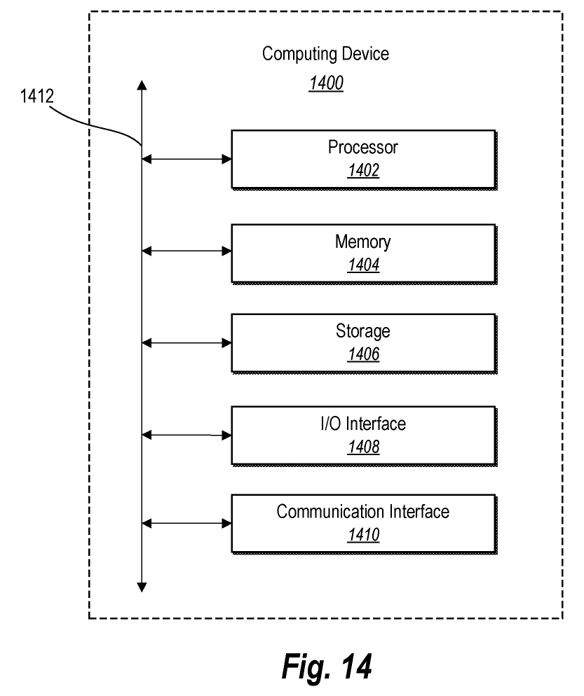

FIG. 14 illustrates a block diagram of an example computing device 1400 that may be configured to perform one or more of the processes described above. One will appreciate that one or more computing devices, such as the computing device 1400 may represent the computing devices described above (e.g., the server device(s) 1206 and/or the client device(s) 1212). In one or more embodiments, the computing device 1400 may be a mobile device (e.g., a mobile telephone, a smartphone, a PDA, a tablet, a laptop, a camera, a tracker, a watch, a wearable device). In some embodiments, the computing device 1400 may be a non-mobile device (e.g., a desktop computer or another type of client device). Further, the computing device 1400 may be a server device that includes cloud-based processing and storage capabilities.

As shown in FIG. 14, the computing device 1400 can include one or more processor(s) 1402, memory 1404, a storage device 1406, input/output interfaces 1408 (or “I/O interfaces 1408”), and a communication interface 1410, which may be communicatively coupled by way of a communication infrastructure (e.g., bus 1412). While the computing device 1400 is shown in FIG. 14, the components illustrated in FIG. 14 are not intended to be limiting. Additional or alternative components may be used in other embodiments. Furthermore, in certain embodiments, the computing device 1400 includes fewer components than those shown in FIG. 14. Components of the computing device 1400 shown in FIG. 14 will now be described in additional detail.

In particular embodiments, the processor(s) 1402 include hardware for executing instructions, such as those making up a computer program. As an example, and not by way of limitation, to execute instructions, the processor(s) 1402 may retrieve (or fetch) the instructions from an internal register, an internal cache, memory 1404, or a storage device 1406 and decode and execute them.

The computing device 1400 includes memory 1404, which is coupled to the processor(s) 1402. The memory 1404 may be used for storing data, metadata, and programs for execution by the processor(s). The memory 1404 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1404 may be internal or distributed memory.

The computing device 1400 includes a storage device 1406 including storage for storing data or instructions. As an example, and not by way of limitation, the storage device 1406 can include a non-transitory storage medium described above. The storage device 1406 may include a hard disk drive (HDD), flash memory, a Universal Serial Bus (USB) drive or a combination these or other storage devices.

As shown, the computing device 1400 includes one or more I/O interfaces 1408, which are provided to allow a user to provide input to (such as user strokes), receive output from, and otherwise transfer data to and from the computing device 1400. These I/O interfaces 1408 may include a mouse, keypad or a keyboard, a touch screen, camera, optical scanner, network interface, modem, other known I/O devices or a combination of such I/O interfaces 1408. The touch screen may be activated with a stylus or a finger.

The I/O interfaces 1408 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1408 are configured to provide graphical data to a display for presentation to a user. The graphical data may be representative of one or more graphical user interfaces and/or any other graphical content as may serve a particular implementation.

The computing device 1400 can further include a communication interface 1410. The communication interface 1410 can include hardware, software, or both. The communication interface 1410 provides one or more interfaces for communication (such as, for example, packet-based communication) between the computing device and one or more other computing devices or one or more networks. As an example, and not by way of limitation, communication interface 1410 may include a network interface controller (NIC) or network adapter for communicating with an Ethernet or other wire-based network or a wireless NIC (WNIC) or wireless adapter for communicating with a wireless network, such as a WI-FI. The computing device 1400 can further include a bus 1412. The bus 1412 can include hardware, software, or both that connects components of computing device 1400 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed:

1. A computer-implemented method comprising:
in response to a request to activate an autonomous software agent to perform a software coding task, deploying the autonomous software agent that operates as an independent virtual machine computing device;
generating, utilizing the autonomous software agent to perform the software coding task in an integrated development environment of the autonomous software agent, computer code responsive to the request; and
in parallel with generating the computer code, providing, via a graphical user interface on a user computing device, the integrated development environment of the autonomous software agent, wherein the graphical user interface displays actions taken by the autonomous software agent while independently performing the software coding task.

2. The computer-implemented method of claim 1, wherein the graphical user interface displays the actions taken by the autonomous software agent, the actions comprising:
commands submitted by the autonomous software agent via a terminal while performing the software coding task;
computer code being written by the autonomous software agent via an editor while performing the software coding task; or
computer code being debugged by the autonomous software agent while performing the software coding task.

3. The computer-implemented method of claim 1, wherein providing, via the graphical user interface, the integrated development environment of the autonomous software agent further comprises providing one or more options to switch between different levels of autonomy for the autonomous software agent.

4. The computer-implemented method of claim 3, wherein providing the one or more options comprises:
providing an option for the user computing device to perform pair programming with the autonomous software agent, wherein pair programming includes the user computing device submitting inputs to guide the autonomous software agent; and
providing an additional option for the user computing device to intervene in the integrated development environment of the autonomous software agent to cause the autonomous software agent to stop performing the software coding task.

5. The computer-implemented method of claim 4, wherein providing the additional option to intervene comprises:
receiving a selection from the user computing device of the additional option to intervene in the integrated development environment; and
receiving user computer code from the user computing device via the integrated development environment of the autonomous software agent.

6. The computer-implemented method of claim 5, further comprising:
receiving an indication from the user computing device for the autonomous software agent to resume performing the software coding task based on the user computer code received from the user computing device; and
generating, utilizing the autonomous software agent, additional computer code to complete the software coding task.

7. The computer-implemented method of claim 1, wherein generating the computer code responsive to the request comprises:
accessing, via the autonomous software agent, one or more code repositories that are accessible to the user computing device; and
generating the computer code to add to existing computer code in the one or more code repositories or to modify the existing computer code in the one or more code repositories.

8. The computer-implemented method of claim 1, further comprising:
providing, via the graphical user interface on the user computing device, a timelapse feature to selectively review the integrated development environment of the autonomous software agent when performing the software coding task;
receiving a selection from the user computing device of the timelapse feature at an indicated point of a development session of the autonomous software agent; and
providing, via the graphical user interface on the user computing device, the integrated development environment, wherein the graphical user interface displays actions taken by the autonomous software agent starting at the indicated point of the development session.

9. A system comprising:
one or more memory devices; and
one or more processors coupled to the one or more memory devices, configured to cause the system to:
in response to a request to activate an autonomous software agent to perform a software coding task, deploy the autonomous software agent that operates as an independent virtual machine computing device;
generate, utilizing the autonomous software agent to perform the software coding task in an integrated development environment of the autonomous software agent, computer code responsive to the request;
provide, via a graphical user interface on a user computing device, the integrated development environment of the autonomous software agent, wherein the graphical user interface displays actions taken by the autonomous software agent while independently performing the software coding task; and
provide, via the graphical user interface, one or more options to perform pair programming with the autonomous software agent via the integrated development environment or to intervene in the integrated development environment and cause the autonomous software agent to stop performing the software coding task.

10. The system of claim 9, wherein the one or more processors are configured to cause the system to:
access, via the autonomous software agent, one or more code repositories that are accessed by the user computing device, wherein the one or more code repositories are part of a centralized development platform for one or more user computing devices; and
deploy the autonomous software agent to perform the software coding task by utilizing the one or more code repositories as context for generating the computer code responsive to the request.

11. The system of claim 9, wherein the one or more processors are configured to cause the system to display the actions taken by the autonomous software agent, wherein the actions comprise:
computer code being written by the autonomous software agent via an editor while performing the software coding task;
computer code in a code repository being edited by the autonomous software agent while performing the software coding task;
project files accessed by the autonomous software agent from one or more code repositories; or
computer code being converted into executable program code by the autonomous software agent via a compiler.

12. The system of claim 9, wherein the one or more processors are configured to cause the system to:
provide an option, via the graphical user interface, to follow the autonomous software agent performing the software coding task;
receive a selection of the option from the user computing device to follow the autonomous software agent; and
in response to the selection of the option from the user computing device, provide, via the graphical user interface, the actions taken by the autonomous software agent while independently performing the software coding task.

13. The system of claim 9, wherein the one or more processors are configured to cause the system to provide different levels of autonomy for the autonomous software agent comprising:
an option for the user computing device to perform pair programming with the autonomous software agent, wherein pair programming includes the user computing device submitting inputs to guide the autonomous software agent; and
an additional option for the user computing device to intervene in the integrated development environment of the autonomous software agent for the user computing device to add to or modify the computer code written by the autonomous software agent in the integrated development environment.

14. The system of claim 13, wherein the one or more processors are configured to cause the system to:
receive a selection of the option to perform pair programming with the autonomous software agent; and
during pair programming, provide a plurality of shortcuts for the user computing device to submit via the integrated development environment,
wherein the plurality of shortcuts comprises adding comments, collapsing code blocks in the integrated development environment, navigating files in the integrated development environment, and triggering computer code completions in the integrated development environment.

15. The system of claim 13, wherein the one or more processors are configured to cause the system to:
receive a selection of the additional option to intervene in the integrated development environment of the autonomous software agent;
pause the autonomous software agent from performing the software coding task;
receive, via the integrated development environment of the autonomous software agent, user computer code from the user computing device; and
receive an indication from the user computing device for the autonomous software agent to independently resume performing the software coding task based on the user computer code from the user computing device.

16. A non-transitory computer-readable medium storing executable instructions which, when executed by at least one processing device, cause the at least one processing device to perform operations comprising:
in response to a request to activate an autonomous software agent to perform a software coding task, deploying the autonomous software agent that operates as an independent virtual machine computing device;
generating, utilizing the autonomous software agent to perform the software coding task in an integrated development environment of the autonomous software agent, computer code responsive to the request; and
providing, via a graphical user interface on a user computing device, the integrated development environment of the autonomous software agent and a timelapse feature to selectively review the integrated development environment of the autonomous software agent across a development session of the autonomous software agent when performing the software coding task.

17. The non-transitory computer-readable medium of claim 16, wherein providing the timelapse feature comprises:
providing a toggle element, via the graphical user interface, for the user computing device to indicate a specific point in the development session of the autonomous software agent executing the software coding task; and
providing as part of the timelapse feature a progress tab, a shell tab, a browser tab, and an editor tab for the user computing device.

18. The non-transitory computer-readable medium of claim 17, wherein:
providing the progress tab comprises providing an overview of sequential meta-events performed by the autonomous software agent starting at a selected point in the development session; and
providing the shell tab comprises providing command history of the autonomous software agent starting at the selected point in the development session.

19. The non-transitory computer-readable medium of claim 17, wherein:
providing the browser tab comprises providing a browsing history of the autonomous software agent starting at a selected point in the development session; and
providing the editor tab comprises providing a history of computer code changes starting at the selected point in the development session.

20. The non-transitory computer-readable medium of claim 16, wherein deploying the autonomous software agent further comprises:
providing an interactive browser option via the graphical user interface of the user computing device;
receiving, via the graphical user interface, a selection of the interactive browser option; and
providing, via the graphical user interface on the user computing device, browser activity of the autonomous software agent utilizing a browser while independently performing the software coding task.
